(19) United States
(12) Patent Application Publication
(10) Pub. No.: US 2026/0118791 A1
(43) Pub. Date: Apr. 30, 2026

(54) TONER

(71) Applicant: CANON KABUSHIKI KAISHA, Tokyo (JP)

(72) Inventors: MASATAKE TANAKA, Kanagawa (JP); SHOHEI KOTOTANI, Shizuoka (JP)

(21) Appl. No.: 19/341,725

(22) Filed: Sep. 26, 2025

(30) Foreign Application Priority Data
Oct. 25, 2024 (JP) 2024-188221

(51) Int. Cl. G03G 9/093; G03G 9/08

(52) U.S. Cl. CPC G03G 9/09328; G03G 9/0819; G03G 9/0823; G03G 9/09342; G03G 9/09371

(57) ABSTRACT

A toner comprising: a toner particle; and a fine particle A and a fine particle B on a surface of the toner particle, wherein the fine particle A is an organosilicon polymer particle and comprises a specific content of specific toluene-soluble matter, the fine particle B has a specific volume resistivity, a content of the fine particle B in the toner is in a specific range, and when a total area of the fine particle B present on a contour of a section of the toner particle and within 30 nm from the contour of the section of the toner particle is defined as B1 (pixel) and a total area of the fine particle B present outside the contour of the section of the toner particle is defined as B2 (pixel) in section observation of the toner with a scanning transmission electron microscope, B1 and B2 satisfy a specific relationship.

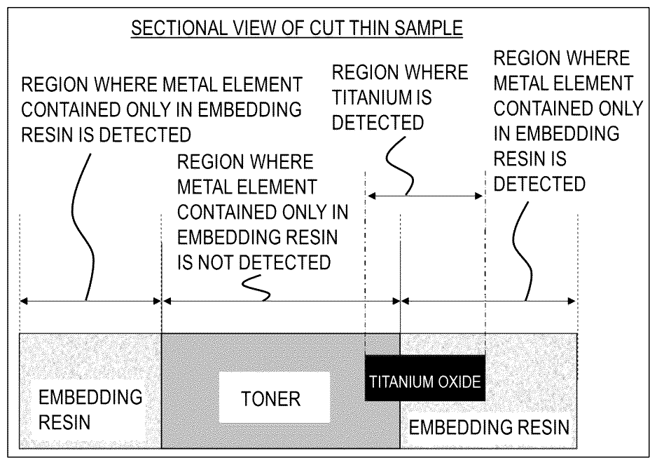

### BACKGROUND

### Field of the Technology

The present disclosure relates to a toner that is used in an image forming method such as an electrophotographic method, an electrostatic recording method, and a toner jet method.

### Description of the Related Art

Printers and copiers have been required to allow high image quality and have high durability, and various types of toners have so far been developed for this purpose. For example, Japanese Patent Application Laid-open No. 2010-197853 has proposed a toner to which polytetrafluoroethylene (PTFE) particles are externally added for the purpose of a lubricant that curbs wearing of members and adhesion of external additives to members.

However, while fluorine compounds have the above-described excellent effects due to their specific characteristics, there has been concern about the effects thereof on the environment and the human body, leading to a strong desire in recent years for an alternative thereto.

Japanese Patent Application Laid-open No. 2019-028238 has proposed a toner using a PTFE particle as a lubricant particle and a toner using a fatty acid metal salt particle as a lubricant particle.

### SUMMARY

According to Japanese Patent Application Laid-open No. 2019-028238, a toner that can curb image a decrease in density and defects due to contamination of members can be obtained. However, according to the studies of the inventors, it is not possible to state that the toner according to Japanese Patent Application Laid-open No. 2019-028238 is sufficiently durable in printers required to have long lifetimes in recent years.

The present disclosure provides a toner that is excellent in durability without using a fluorine compound in consideration of effects on the environment and the human body. Specifically, the present disclosure provides a toner that curbs toner degradation due to a stress received from long-term printing, curbs image defects such as fogging in an environment at a normal temperature and a normal humidity and an environment at a low temperature and a low humidity and a decrease in density in an environment at a low temperature and a low humidity, and also curbs image flow by curbing surface contamination of a latent image bearing member.

The image flow is a phenomenon as will be described below. In other words, ozone generated in a process of charging a latent image bearing member reacts with nitrogen in the air to generate nitrogen oxides (NOx) and then reacts with moisture in the air to become nitric acid. Then, the nitric acid adheres to the surface of the latent image bearing member and decreases the resistance on the surface of the latent image bearing member. The phenomenon that the latent image on the latent image bearing member is disordered during image formation as a result is image flow.

The present disclosure relates to a toner comprising: a toner particle; and a fine particle A and a fine particle B on a surface of the toner particle, wherein the fine particle A is an organosilicon polymer particle, the fine particle A comprises 0.20% by mass to 5.00% by mass of toluene-soluble matter having a molecular weight of 1,000 to 10,000 with respect to the fine particle A, a volume resistivity of the fine particle B is 5.0×10¹ to 1.0×10⁸Ω·m, a content of the fine particle B in the toner is 0.1 to 3.0 parts by mass with respect to 100 parts by mass of the toner particle, and when a total area of the fine particle B which is present on a contour of a section of the toner particle and within 30 nm from the contour of the section of the toner particle is defined as B1 (pixel) and a total area of the fine particle B which is present outside the contour of the section of the toner particle is defined as B2 (pixel) in section observation of the toner with a scanning transmission electron microscope, B1 and B2 satisfy Expression (1) below.

$$50 \leq B 1 / ( B 1 + B 2 ) \times 100 \leq 100. \qquad ( 1 )$$

Features of the present disclosure will become apparent from the following description of embodiments with reference to the attached drawing. The following description of embodiments is described by way of example.

### BRIEF DESCRIPTION OF THE DRAWING

The Figure is an explanatory diagram illustrating a section of a cut thin sample.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

In the present disclosure, “(meth)acrylic” means “acrylic” and/or “methacrylic”.

Hereinafter, a toner of the present disclosure will be described in further detail.

As a result of intensive studies to solve the above-described problems of the prior art, the present inventors have found that the toner of the present disclosure can solve the above problems.

That is, the present disclosure relates to a toner comprising: a toner particle; and a fine particle A and a fine particle B on a surface of the toner particle, wherein the fine particle A is an organosilicon polymer particle, the fine particle A comprises 0.20% by mass to 5.00% by mass of toluene-soluble matter having a molecular weight of 1,000 to 10,000 with respect to the fine particle A, a volume resistivity of the fine particle B is 5.0×10¹ to 1.0×10⁸Ω·m, a content of the fine particle B in the toner is 0.1 to 3.0 parts by mass with respect to 100 parts by mass of the toner particle, and when a total area of the fine particle B which is present on a contour of a section of the toner particle and within 30 nm from the contour of the section of the toner particle is defined as B1 (pixel) and a total area of the fine particle B which is present outside the contour of the section of the toner particle is defined as B2 (pixel) in section observation of the toner with a scanning transmission electron microscope, B1 and B2 satisfy Expression (1) below.

$$50 \leq B 1 / ( B 1 + B 2 ) \times 100 \leq 100. \qquad ( 1 )$$

The present inventors consider a mechanism for achieving the effects of the present disclosure as follows.

A toner surface and member surfaces are very thinly coated with an organosilicon polymer component from the fine particle A through rubbing between toners and between the toner and members during an electrophotographic process. Thus, surface contamination of the toner and the members due to discharge products and free external additives is curbed. Even if the surfaces of the toner and the members are contaminated, changes in surface states of the toner and the members are curbed by repeating removal and recoating while the coating layer is being rubbed. It is considered that durability of the toner is improved as a result.

The fine particle A, which is an organosilicon polymer particle, contains an organic group. Therefore, the fine particle A has more appropriate flexibility than silica external additives. This is considered to contribute to coating the members without excessively damaging them. Also, the fine particle A of the organosilicon polymer contains a toluene-soluble matter having a molecular weight within a predetermined range. It is considered that this toluene-soluble matter is a starting point of the coating.

The surface of the toner is formed such that an embedding rate of the fine particle B with a volume resistivity falling within a predetermined range is controlled to be within a predetermined range. The embedding rate is represented by B1/(B1+B2)×100 as described above. It is considered that electrical repulsion against the coating component is curbed by the volume resistivity falling within a predetermined range, which contributes to homogeneous coating. Also, it is considered that the embedding rate falling within the above range curbs liberation even after repeated rubbing and contributes to lasting effects. It is considered that the above-described effects work synergistically and exert the effects of the present disclosure.

Each component that may constitute the toner and a method of producing the toner will be described in detail.

### Binder Resin

The toner contains a toner particle. The toner particle preferably contains a binder resin. The content of the binder resin is preferably 50% by mass or more, and is more preferably 75% by mass or more with respect to the total amount of the resin component in the toner particle. The upper limit is not particularly limited, and the content of the binder resin may be 50% by mass to 100% by mass, 75% by mass to 100% by mass, or 75% by mass to 90% by mass with respect to the total amount of resin component in the toner particle.

The binder resin is not particularly limited, and examples thereof include a styrene acrylic resin, an epoxy resin, a polyester resin, a polyurethane resin, a polyamide resin, a cellulose resin, a polyether resin, a mixed resin or a composite resin thereof, and the like. An amorphous styrene acrylic resin or an amorphous polyester resin is preferable from the viewpoint of being inexpensive, easily available, and excellent in low-temperature fixability.

The polyester resin is obtained by selecting and then combining preferred compounds from among polycarboxylic acids, polyols, hydroxycarboxylic acids, and the like, and synthesizing the resin with the use of a conventionally known method such as a transesterification method or a polycondensation method, for example.

Polycarboxylic acids are compounds containing two or more carboxy groups in one molecule. Among these compounds, a dicarboxylic acid is a compound containing two carboxy groups in one molecule, and is preferably used.

Examples of the dicarboxylic acid include dicarboxylic acids such as oxalic acid, succinic acid, glutaric acid, maleic acid, adipic acid, P-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylene diacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid. Among these, at least one selected from the group consisting of a terephthalic acid and a fumaric acid is preferable.

Examples of polycarboxylic acids other than dicarboxylic acids include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid, and n-octenyl succinic acid. Among these, at least one selected from the group consisting of n-dodecyl succinic acid and trimellitic acid is preferable.

These may be used alone or two or more thereof may be used in combination.

Polyols are compounds containing two or more hydroxyl groups in one molecule. Among the compounds, a diol is a compound containing two hydroxyl groups in one molecule, and is preferably used.

Specific examples thereof include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, an alkylene oxide (ethylene oxide, propylene oxide, butylene oxide, or the like) adducts of the bisphenols mentioned above, and the like.

Among these compounds, alkylene glycols having 2 to 12 carbon atoms and alkylene oxide adducts of bisphenols are preferred, and alkylene oxide adducts of bisphenols and combinations thereof with alkylene glycols having 2 to 12 carbon atoms are particularly preferred.

Examples of trivalent or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of trivalent or higher polyphenols. One of these compounds may be used alone, or two or more thereof may be used in combination.

Examples of the styrene acrylic resin include homopolymers made from the following polymerizable monomers, copolymers obtained from two or more of the monomers in combination, or mixtures thereof:
styrene, styrene-based monomers such as a-methylstyrene, P-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers such as methyl (meth)acrylate, ethyl(meth)acrylate, n-propyl (meth)acrylate, iso-propyl (meth)acrylate, n-butyl (meth)acrylate, iso-butyl (meth)acrylate, tert-butyl (meth)acrylate, n-amyl(meth)acrylate, n-hexyl(meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid;
vinyl ether-based monomers such as vinyl methyl ether and vinyl isobutyl ether;
vinyl ketone-based monomers such as vinyl methyl ketone, vinyl ethyl ketone, and vinyl isopropenyl ketone; and
polyolefins such as ethylene, propylene, and butadiene.

As the styrene acrylic resin, a polyfunctional polymerizable monomer can be used, if necessary. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexandiol di(meth)acrylate, neopentyl glycol di(meth)acrylate, tripropylene glycol di(meth)acrylate, polypropylene glycol di(meth)acrylate, 2,2′-bis(4-((meth)acryloxy diethoxy)phenyl)propane, trimethylolpropane tri(meth)acrylate, tetramethylolmethane tetra(meth)acrylate, divinylbenzene, divinylnaphthalene, divinyl ether.

In addition, it is also possible to further add known chain transfer agents and polymerization inhibitors to control the degree of polymerization.

Examples of polymerization initiators for obtaining styrene acrylic resins include organic peroxide-based initiators and azo-based polymerization initiators.

Examples of the organic peroxide-based initiators include benzoyl peroxide, lauroyl peroxide, di-a-cumyl peroxide, 2,5-dimethyl-2,5-bis(benzoylperoxy)hexane, bis(4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butyl-peroxypivalate.

Examples of the azo-based polymerization initiators include 2,2′-azobis-(2,4-dimethylvaleronitrile), 2,2′-azobisisobutyronitrile, 1,1′-azobis(cyclohexane-1-carbonitrile), 2,2′-azobis-4 methoxy-2,4-dimethylvaleronitrile and azobismethylbutyronitrile, and 2,2′-azobis-(methyl isobutyrate).

In addition, a redox-based initiator that has an oxidizing substance and a reducing substance combined can also be used as a polymerization initiator.

Examples of the oxidizing substance include hydrogen peroxide, inorganic peroxides of persulfates (sodium salts, potassium salts, and ammonium salts), and oxidizing metal salts of tetravalent cerium salts.

Examples of the reducing substance include reducing metal salts (divalent iron salts, monovalent copper salts, and trivalent chromium salts), ammonia, lower amines (amines having from 1 to 6 carbon atoms, such as methylamine and ethylamine), amino compounds such as hydroxylamine, reducing sulfur compounds such as sodium thiosulfate, sodium hydrosulfite, sodium bisulfite, sodium sulfite, and sodium formaldehyde sulfoxylate, lower alcohols (carbon atoms from 1 to 6), ascorbic acid or salts thereof, and lower aldehyde (carbon atoms from 1 to 6).

The polymerization initiators are selected with reference to the 10-hour half-life temperature, and utilized alone or in mixture. Although the amount of the polymerization initiator added changes depending on the intended degree of polymerization, 0.5 parts by mass to 20.0 parts by mass of polymerization initiator is added to 100.0 parts by mass of the polymerizable monomer, for example.

### Release Agent

For the toner, a known wax can be used as a release agent. The toner particle preferably contains a release agent.

Specific examples thereof include petroleum-based wax represented by paraffin wax, microcrystalline wax, or petrolactam and derivatives thereof, montan wax and derivatives thereof, hydrocarbon wax obtained by a Fischer-Tropsch method and derivatives thereof, polyolefin wax represented by polyethylene and derivatives thereof, and natural wax represented by carnauba wax or candelilla wax and derivatives thereof, and the derivatives also include oxides, block copolymers with a vinyl monomer, and graft modified products.

In addition, the examples include alcohols such as higher aliphatic alcohols; fatty acids such as stearic acid and palmitic acid, or acid amides, esters, and ketones thereof; hydrogenated castor oils and derivatives thereof, plant waxes, and animal waxes. These waxes may be used alone or in combination.

In the case of using, among these, at least one selected from the group consisting of the polyolefin, the hydrocarbon wax obtained by the Fischer-Tropsch method, and the petroleum-based wax, the developing performance and the transferability tend to be improved, which is preferred. Among others, the hydrocarbon wax is more preferable. An antioxidant may be added to these waxes to the extent that the characteristics of the toner are not affected.

In addition, from the viewpoint of phase separation from the binder resin or crystallization temperature, higher fatty acid esters such as behenyl behenate and dibehenyl sebacate can be suitably exemplified.

The content of the release agent is preferably from 1.0 parts by mass to 30.0 parts by mass with respect to 100.0 parts by mass of the binder resin.

The melting point of the release agent is preferably from 30° C. to 120° C., more preferably from 60° C. to 100° C. With the use of the release agent that has a melting point from 30° C. to 120° C., the release effect is efficiently exhibited, and a larger fixing region is secured.

### Plasticizer

For the toner of the present disclosure, a crystalline plasticizer is preferably used to improve sharp meltability. The plasticizer is not particularly limited, and any known plasticizer used in toner as below can be used.

Esters of a monovalent alcohol and an aliphatic carboxylic acid such as behenyl behenate, stearyl stearate, and pulmiyl palmitate, or esters of a monovalent carboxylic acid and an aliphatic alcohol; Esters of a divalent alcohol and an aliphatic carboxylic acid such as ethylene glycol distearate, dibehenyl sebacate, hexandiol dibehenate, or esters of a divalent carboxylic acid and an aliphatic alcohol; Esters of a trivalent alcohol and an aliphatic carboxylic acid, such as glycerin tribehenate, or esters of a trivalent carboxylic acid and an aliphatic alcohol; Esters of a tetravalent alcohol and an aliphatic carboxylic acid, such as pentaerythritol tetrastearate, pentaerythritol tetrapalmitate, or esters of a tetravalent carboxylic acid and an aliphatic alcohol; Esters of a hexaalcohol and an aliphatic carboxylic acid, such as dipentaerythritol hexastearate, dipentaerythritol hexapalmitate, or esters of a hexacarboxylic acid and an aliphatic alcohol; Esters of polyhydric alcohols and aliphatic carboxylic acids, such as polyglycerin behenate, or esters of polyhydric carboxylic acids and aliphatic alcohols; Natural ester waxes such as carnauba wax and rice wax. These may be used individually or in combination.

### Crystalline Polyester Resin

The toner particle preferably contains a crystalline polyester resin from the viewpoint of curbing fogging at a low temperature and a low humidity. The crystalline polyester resin has a leakage property. It is considered that the crystalline polyester resin acts on the embedded fine particle B and curbs overcharging at a low temperature and a low humidity, in particular, as a result.

The crystalline polyester resin can be obtained by a reaction between a divalent or higher valency carboxylic acid and a polyhydric alcohol. A crystalline polyester resin mainly containing an aliphatic dicarboxylic acid and an aliphatic diol as main ingredients is preferable because a desired melting point is easily obtained and the crystalline polyester resin has a high degree of crystallinity.

Examples of the polyhydric alcohol include ethylene glycol, diethylene glycol, triethylene glycol, 1,2-propanediol, 1,3-propanediol, dipropylene glycol, tetramethylene glycol, pentamethylene glycol, hexamethylene glycol, octamethylene glycol, nonamethylene glycol, decamethylene glycol, dodecamethylene glycol, neopentyl glycol, 1,4-butadiene glycol, and the like.

Preferably, the polyhydric alcohol is at least one polyhydric alcohol selected from the group consisting of α,ω-linear aliphatic diol having from 2 to 12 carbon atoms (more preferably from 4 to 10 carbon atoms).

Examples of polycarboxylic acids include oxalic acid, malonic acid, succinic acid, glutaric acid, adipic acid, pimelic acid, spelic acid, glutaonic acid, azelaic acid, sebacic acid, nonanedicarboxylic acid, decanedicarboxylic acid, undecanedicarboxylic acid, maleic acid, fumaric acid, mesic acid, citraconic acid, itaconic acid, isophthalic acid, terephthalic acid, n-dodecyl succinic acid, n-decenylsuccinic acid, cyclohexanedicarboxylic acid, anhydrides or lower alkyl esters of these acids, and the like.

Preferably, the polycarboxylic acid is at least one multivalent carboxylic acid selected from the group consisting of α,ω-linear aliphatic dicarboxylic acids having from 2 to 14 carbon atoms (more preferably from 4 to 12 carbon atoms), and anhydrides or lower alkyl esters of these acids.

In order to adjust an acid value and a hydroxyl value of the crystalline polyester resin, a method of sealing a polymer end is exemplified, for example, and at that time, it is preferable to seal the polymer end to have an alkyl chain having 6 or more carbon atoms. This makes it easier to obtain an effect of improving heat-resistant storability.

Monovalent acids or monovalent alcohols are used to seal the polymer end. Examples of the monovalent acids include acetic acid, propionic acid, butyric acid, octanoic acid, decanoic acid, dodecanoic acid, stearic acid, behenic acid, and the like. Examples of the monovalent alcohols include methanol, ethanol, propanol, butanol, octanol, decanol, dodecanol, stearyl alcohol, behenyl alcohol, and the like.

The content of crystalline polyester resin in the toner particle is not particularly limited and may be 1.0% by mass to 15.0% by mass or may be 5.0% by mass to 10.0% by mass.

### Colorant

The toner particle may contain a colorant. Known pigments and dyes can be used as the colorant. From the viewpoint of excellent weather resistance, pigments are preferred as the colorant.

Examples of cyan-based colorants include copper phthalocyanine compounds and derivatives thereof, anthraquinone compounds, and basic dye lake compounds.

Specific examples thereof include the following: C.I.Pigment Blue 1, 7, 15, 15:1, 15:2, 15:3, 15:4, 60, 62, and 66.

Examples of magenta-based colorants include condensed azo compounds, diketopyrrolopyrrole compound, anthraquinone compounds, quinacridone compounds, basic dye lake compounds, naphthol compounds, benzimidazolone compounds, thioindigo compounds, and perylene compounds.

Specific examples thereof include the following: C.I.Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I.Pigment Violet 19.

Examples of yellow-based colorants include condensed azo compounds, isoindolinone compounds, anthraquinone compounds, azo metal complexes, methine compounds, and allylamide compounds.

Specific examples thereof include the following: C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include colorants subjected to color matching to black with the use of the above-mentioned yellow-based colorants, magenta-based colorants, and cyan-based colorant, and carbon black.

These colorants can be used alone or in mixture, and used in the form of a solid solution.

The colorant is preferably used in an amount from 1.0 parts by mass to 20.0 parts by mass with respect to 100.0 parts by mass of binder resin.

### Charge Control Agent and Charge Control Resin

The toner particle may contain a charge control agent or a charge control resin.

As the charge control agent, known charge control agents can be used, and in particular, a charge control agent that is high in triboelectric charging speed and capable of stably maintaining a constant triboelectric charge quantity is preferred. Furthermore, in the case of producing toner particles by a suspension polymerization method, a charge control agent is particularly preferred, which is low in polymerization inhibition performance and substantially free of solubilized products in the aqueous medium.

Examples of agents that control the toner to be negatively charged include monoazo metal compounds, acetylacetone metal compounds, aromatic oxycarboxylic acid, aromatic dicarboxylic acid, and oxycarboxylic and dicarboxylic acid-based metal compounds, aromatic oxycarboxylic acids, aromatic mono- and poly-carboxylic acids, and metal salts, anhydrides, and esters thereof, phenol derivatives such as bisphenol, urea derivatives, metal-containing salicylic acid-based compounds, metal-containing naphthoic acid-based compounds, boron compounds, quaternary ammonium salts, calixarenes, and charge control resins.

Examples of the charge control resin can include polymers or copolymers having a sulfonic acid group, a sulfonic acid base, or a sulfonic acid ester group. The polymer having a sulfonic acid group, a sulfonic acid base, or a sulfonic acid ester group is preferably, in particular, a polymer containing a sulfonic acid group-containing acrylamide-base monomer or a sulfonic acid group-containing methacrylamide-based monomer in a copolymerization ratio of 2% by mass or more, more preferably 5% by mass or more.

The charge control resin preferably has a glass transition temperature (Tg) from 35° C. to 90° C., a peak molecular weight (Mp) from 10,000 to 30,000, and a weight-average molecular weight (Mw) from 25,000 to 50,000. When this resin is used, preferred triboelectric charging characteristics can be imparted without affecting the thermal characteristics required for the toner particle. Furthermore, when the charge control resin contains a sulfonic acid group, for example, the dispersibility of the charge control resin itself in the polymerizable monomer composition and the dispersibility of the colorant or the like are improved, thereby allowing the tinting strength, the transparency, and the triboelectric charging characteristics to be further improved.

These charge control agents or charge control resins may be added alone or, two or more thereof may be added in combination.

The amount of the charge control agent or charge control resin added is preferably from 0.01 parts by mass to 20.0 parts by mass, more preferably from 0.5 parts by mass to 10.0 parts by mass or with respect to 100.0 parts by mass of binder resin.

The toner particle preferably has a core-shell structure in terms of curbing fogging after duration and curbing a decrease in image density. The core-shell structure means that the toner particle has a core particle and a shell formed on the surface of the core particle.

The core particle can contain each component that may constitute the above-described toner, and preferably contains the above-described binder resin.

Also, the shell particle can contain each component that may constitute the above-described toner, and preferably contains the above-described binder resin. The amount of resin to be added for the shell is preferably from 1 part by mass to 10 parts by mass and is more preferably from 2 parts by mass to 7 parts by mass with respect to 100 parts by mass of binder resin contained in the core particle.

### Fine Particle A

The toner has the fine particle A on the surface of the toner particle. The fine particle A is an organosilicon polymer particle.

The fine particle A contains 0.20% by mass to 5.00% by mass of a toluene-soluble matter having a molecular weight of 1,000 to 10,000 with respect to the fine particle A. As described above, since the fine particle A is an organosilicon polymer particle, the fine particle A contains an organic group. Therefore, the fine particle A has more appropriate flexibility than silica external additives. Thus, the surface of the toner and the surface of the electrophotographic member are very thinly coated with the organosilicon polymer component from the organosilicon polymer particle during the electrophotographic process.

On the other hand, the fact that the fine particle A contains the toluene-soluble matter having a molecular weight of 1,000 to 10,000 indicates that the fine particle A contains a component with a low molecular weight and higher flexibility. It is considered that this results in easiness of the above coating.

The content of toluene-soluble matter having a molecular weight of 1,000 to 10,000 with respect to the fine particle A is required to be 0.20% by mass to 5.00% by mass, is preferably 0.20% by mass to 3.00% by mass, and is more preferably 0.50% by mass to 2.50% by mass.

Methods of adjusting and measuring the content of toluene-soluble matter having a molecular weight of 1,000 to 10,000 with respect to the fine particle A will be described later.

The organosilicon polymer particle is preferably a polymer of an organosilicon compound having a structure represented by Formula (3) below.

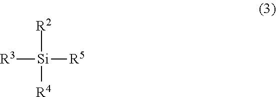

In Formula (3), R², R³, R⁴ and R⁵ each independently represent an alkyl group having 1 to 6 (more preferably 1 to 4) carbon atoms, a phenyl group, or a reactive functional group (for example, a halogen atom, a hydroxy group, an acetoxy group, or an alkoxy group having 1 to 6 (more preferably 1 to 4) carbon atoms), and at least one selected from the group consisting of R², R³, R⁴ and R⁵ is a reactive functional group.

In order to obtain the organosilicon polymer particle, it is possible to use the following organosilicon compounds, for example. Among others, the organosilicon compound is preferably a trifunctional silane.

An organosilicon compound (tetrafunctional silane) in which in Formula (3) above, all R², R³, R⁴, and R⁵ are each independently a reactive functional group

An organosilicon compound (trifunctional silane) in which in Formula (3) above, one selected from the group consisting of R², R³, R⁴, and R⁵ is an alkyl group or a phenyl group, and the rest three are each independently a reactive functional group

An organosilicon compound (bifunctional silane) in which in Formula (3) above, two selected from the group consisting of R², R³, R⁴, and R⁵ are each independently an alkyl group or a phenyl group, and the rest two are each independently a reactive functional group

An organosilicon compound (monofunctional silane) in which in Formula (3) above, three selected from the group consisting of R², R³, R⁴, and R⁵ are each independently an alkyl group or a phenyl group and the rest one is a reactive functional group

The rate of the area of a peak derived from a T3 unit structure obtained by measuring the organosilicon polymer particle by solid ²⁹Si-NMR is preferably 0.50 to 1.00. In order to cause the rate of the area to fall within the above range, it is preferable to use 50 mol % or more of trifunctional silane as the organosilicon compound.

It is possible to obtain the organosilicon polymer particle by the reactive functional group being hydrolyzed and experiencing addition polymerization and condensation polymerization to thereby form a cross-linked structure. The hydrolysis, the addition polymerization, and the condensation polymerization of the reactive functional group can be controlled by reaction temperatures, reaction times, reaction solvents, and pH.

Examples of tetrafunctional silane include tetramethoxy silane, tetraethoxy silane, tetraisocyanate silane, and the like.

Examples of trifunctional silane include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methyldiacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, phenyltrihydroxysilane, pentyldimethoxysilane, and the like.

Examples of bifunctional silane include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethyldimethoxysilane, diethoxydimethylsilane, diethyldimethoxy silane, and the like.

Examples of monofunctional silane include t-butyldimethylchlorosilane, t-butyldimethylmethoxysilane, t-butyldimethylethoxysilane, t-butyldiphenylchlorosilane, t-butyldiphenylmethoxysilane, t-butyldiphenylethoxysilane, chlorodimethylphenylsilane, methoxydimethylphenylsilane, ethoxydimethylphenylsilane, chlorotrimethylsilane, trimethylmethoxy silane, ethoxytrimethylsilane, triethylmethoxy silane, triethylethoxy silane, tripropylmethoxysilane, tributylmethoxysilane, tripentylmethoxysilane, triphenylchlorosilane, triphenylmethoxysilane, triphenylethoxysilane, and the like. Among others, tripentylmethoxysilane is preferable.

The fine particle A may be surface-treated for the purpose of imparting hydrophobicity. In other words, the fine particle A may be a product surface-treated with a hydrophobic treatment agent.

Examples of the hydrophobic treatment agent include: chlorosilanes such as methyltrichlorosilane, dimethyldichlorosilane, trimethylchlorosilane, phenyltrichlorosilane, diphenyldichlorosilane, t-butyldimethylchlorosilane, and vinyltrichlorosilane; alkoxysilanes such as isobutyltrimethoxysilane, tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, 7-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxy silane, γ-aminopropyltriethoxy ilane, γ-(2-aminoethyl)aminopropyltrimethoxysilane, and γ-(2-aminoethyl)aminopropylmethyldimethoxysilane; silazanes such as hexamethyldisilazane, hexaethyldisilazane, hexapypropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; and siloxanes such as hexamethylcyclotrisiloxane, octamethylcyclotetrasiloxane, decamethylcyclopentasiloxane, hexamethyldisiloxane, and octamethyltrisiloxane.

The fine particle A can be produced by a known method of producing an organosilicon polymer particle. For example, the method of producing the organosilicon polymer particle preferably includes a first process of obtaining a hydrolysate of an organosilicon compound and a second process of mixing the hydrolysate with an alkaline aqueous medium to cause a polycondensation reaction of the hydrolysate and to thereby micronize the product. Also, it is preferable that the method of producing the organosilicon polymer particle further include a third process of mixing the fine particle obtained in the second process with a silane compound, which will be described below.

In the first process, the organosilicon compound and a catalyst are brought into contact with each other in an aqueous solution in which an acidic or alkaline substance serving a catalyst is dissolved in water, by a method such as stirring, mixing, or the like. As the catalyst, a known catalyst can be suitably used. Specifically, examples of an acidic catalyst as the catalyst include acetic acid, hydrochloric acid, hydrofluoride, sulfuric acid, nitric acid, and the like, and examples of a basic catalyst include aqueous ammonia, sodium hydroxide, potassium hydroxide, and the like.

Although a reaction temperature in the first process is not particularly limited, and the first process may be performed at a room temperature or in a heated state, it is preferable to perform the reaction in a state where the reaction temperature is held at 10° C. to 60° C. because a hydrolysate can be obtained in a short period of time and a partial condensation reaction of the generated hydrolysate can be curbed. The reaction time is not particularly limited and can be appropriately selected in consideration of reactivity of the organosilicon compound to be used, a composition of a reaction solution prepared by mixing the organosilicon compound, the catalyst, and water, and the productivity.

In the second process, the hydrolysate obtained in the first process is mixed with an alkaline aqueous medium to cause a polycondensation reaction of the hydrolysate. In this manner, a fine particle is obtained. Here, the alkaline aqueous medium is a liquid obtained by mixing an alkaline component and water.

Although a method of mixing the hydrolysate with the alkaline aqueous medium is not particularly limited, a method of dropping the hydrolysate to the alkaline aqueous medium is preferable.

The alkaline component used in the alkaline aqueous medium is a component, an aqueous solution of which exhibits basic properties, which acts as a neutralizing agent for the catalyst used in the first process and as a catalyst for the polycondensation reaction in the second process. Examples of such an alkali component can include hydroxides of alkali metal, such as lithium hydroxide, sodium hydroxide, and potassium hydroxide; ammonia; and organic amines such as monomethylamine and dimethylamine.

It is preferable to add a silane compound during the process of producing the fine particle A. For example, a silane compound may be added during the above-described first process, and a silane compound may be added during the above-described second process. Also, the method of producing the organosilicon polymer particle preferably includes a third process of mixing the fine particle obtained in the second process with a silane compound. For example, it is possible to add the silane compound by stirring and mixing the fine particle, the silane compound, and an organic solvent.

A silane compound having poor reactivity and a desired molecular weight is preferable. This makes it easy to cause the fine particle A to contain a toluene-soluble matter having a molecular weight of 1,000 to 10,000. Moreover, it is possible to adjust the content of toluene-soluble matter with respect to the fine particle A by adjusting the amount of silane compound.

Examples of the silane compound include silicone oils such as dimethyl silicone oil, methyl hydrogen silicone oil, methylphenyl silicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal reactive silicone oil. These silane compound may be used alone or in combination. Among others, dimethyl silicone oil is preferable.

Although the organic solvent that may be used in the third process is not particularly limited, the organic solvent is preferably an alcoholic solvent such as methanol, ethanol, 2-propanol, or butanol, for example.

When the number average particle diameter of a primary particle of the fine particle A is defined as X (μm), and the weight average particle diameter of the toner is defined as Y (μm), X and Y preferably satisfy Expression (2) below. When Expression (2) below is satisfied, it is easy to curb a decrease in density in an environment at a low temperature and a low humidity and to curb image flow.

$$0.05 \leq X \leq Y \times 0.65 \qquad ( 2 )$$

If X is less than 0.050 μm, the fine particle A may become less likely to rub due to the fine particle A entering a toner recessed portion, for example. As a result, the surface of the toner and the surfaces of members may become less likely to be coated with the fine particle A.

The value of Y×0.65 represents the size relative to the toner particle. In other words, if X exceeds the value of Y×0.65, the fine particle A becomes less likely to be developed with the toner. As a result, a temperature drop in an environment at a low temperature and a low humidity becomes less likely to be curbed, and image flow becomes less likely to be curbed.

The number average particle diameter X (μm) of the primary particle of the fine particle A is preferably 0.040 μm to 5.000 μm, is more preferably 0.050 μm to 4.300 μm, and is further preferably 0.050 μm to 4.000 μm.

The value of X can be changed by adjusting the dropping time of the hydrolysate in the second process, for example. A method of measuring the value of X will be described later.

The content of fine particle A in the toner is preferably 0.1 parts by mass to 1.0 parts by mass with respect to 100 parts by mass of toner particle.

### Fine Particle B

The toner has the fine particle B on the surface of the toner particle. The fine particle B can be used without any particular limitation as long as the volume resistivity thereof is 5.0×10¹ to 1.0×10⁸Ω·m. The volume resistivity falling within the above range indicates that the volume resistivity is relatively low. As described above, it is considered that the volume resistivity falling within the above range curbs electrical repulsion against the coating component and contributes to homogeneous coating.

The fine particle B preferably contains at least one selected from the group consisting of a titanium oxide fine particle, a strontium titanate fine particle, and alumina fine particle, more preferably contains at least one selected from the group consisting of a titanium oxide fine particle and a strontium titanate fine particle, and is particularly a titanium oxide fine particle or a strontium titanate fine particle. In addition, it is also possible to use a composite oxide fine particle using two or more kinds of metal, or it is also possible to use one kind therefrom alone or two or more kinds selected from the group of fine particles in an arbitrary combination.

The volume resistivity of the fine particle B is preferably 1.0×10²Ω·cm to 5.0×10⁷Ω·cm, and is more preferably 1.0×10⁴Ω·cm to 5.0×10⁷Ω·cm. The effects of the present disclosure are more likely to be obtained if the volume resistivity falls within the above-described range.

The volume resistivity of the fine particle B can be adjusted by changing the firing temperature in the production of the fine particle B or by changing the type and the amount of a surface treatment agent when the surface treatment agent is used in the production of the fine particle B, for example.

A method of adjusting the volume resistivity of the fine particle B will be described later.

When the total area of the fine particle B that is present on the contour of the section of the toner particle and within 30 nm from the contour of the section of the toner particle is defined as B1 (pixel) and the total area of the fine particle B that is present outside the contour of the section of the toner particle is defined as B2 (pixel) in the section observation of the toner with a scanning transmission electron microscope, B1 and B2 satisfy Expression (1) below.

$$50 \leq B 1 / ( B 1 + B 2 ) \times 100 \leq 100 \qquad ( 1 )$$

B1/(B1+B2)×100 represents the embedding rate of the fine particle B with respect to the toner particle. The embedding rate falling within the above-described later curbs liberation and embedding even after repeated rubbing and leads to a toner with more excellent durability.

B1 and B2 preferably satisfy Expression (1-1) below and more preferably satisfy Expression (1-2) below.

$$50 \leq B 1 / ( B 1 + B 2 ) \times 100 \leq 95 \qquad ( 1 - 1 )$$

$$60 \leq B 1 / ( B 1 + B 2 ) \times 100 \leq 80 \qquad ( 1 - 2 )$$

A method of calculating B1/(B1+B2)×100 will be described later.

The embedding rate of the fine particle B with respect to the toner particle can be controlled by changing external addition conditions when the fine particle B is externally added to the toner particle, specifically, by changing the temperature, the number of rotations, the time, and the like. For example, it is possible to increase the embedding rate by raising the temperature and to decrease the embedding rate by lowering the temperature. Furthermore, it is possible to increase the embedding rate by extending the external addition time and to decrease the embedding rate by shortening the external addition time.

When the standard deviation of B1/(B1+B2) is defined as C in section observation of the toner with a scanning transmission electron microscope, B1, B2, and C preferably satisfy Expression (3) below.

$$0. \leq C / \{ B 1 / ( B 1 + B 2 ) \} \leq 0.22 \qquad ( 3 )$$

The standard deviation C means variations in how the fine particle B is embedded in the surface of the toner for each field of view of the observation. From the viewpoint that the fine particle B is preferably uniformly embedded in the surface of the toner particle, the standard deviation C is preferably small. A preferable range of the standard deviation C is 0.20 or less, is more preferably 0.15 or less, and is further preferably 0.10 or less. A lower limit of the standard deviation C is not particularly limited, and the range of the standard deviation C may be 0.00 to 0.20, 0.00 to 0.15, 0.00 to 0.10, or 0.02 to 0.10.

Also, C/{B1/(B1+B2)} is an index representing variations in consideration of the embedding rate of the fine particle B. In a case where B1/(B1+B2) is large, that is, in a case where the embedding rate of the fine particle B is high, the fine particle B is uniformly embedded in the surface of the toner particle, and the effects of the present disclosure are thus more likely to be exhibited. In a case where B1/(B1+B2) is large, it is assumed that the effects of the present disclosure, particularly the effect of high fluidity, is likely to be exhibited regardless of the standard deviation C, that is, large differences in embedding rate at each location on the surface of the toner particle since the differences are variations in a region where the embedding rate is high.

On the other hand, in a case where B1/(B1+B2) is small, it is assumed that the effects of the present disclosure, particularly the effect of high fluidity, is less likely to be exhibited unless the standard deviation C is small because the variations are ones in a region where the embedding rate is low. From this point, it is considered that the effects of the present disclosure are more likely to be exhibited by the index C/{B1/(B1+B2)} in consideration of the embedding rate falling within an appropriate range. C/{B1/(B1+B2)} is preferably from 0.00 to 0.22, is more preferably from 0.00 to 0.20, and is further preferably from 0.00 to 0.15. Moreover, C/{B1/(B1+B2)} may be from 0.02 to 0.15.

The content of fine particle B in the toner is 0.1 parts by mass to 3.0 parts by mass with respect to 100 parts by mass of toner particle. It becomes easy to curb fogging in an environment at a normal temperature and a normal humidity and an environment at a low temperature and a low humidity and to curb surface contamination of a latent image bearing member. The content of the fine particle B in the toner is preferably 0.5 parts by mass to 2.0 parts by mass, and is more preferably 0.8 parts by mass to 1.5 parts by mass with respect to 100 parts by mass of toner particle.

A method of measuring the content of fine particle B in the toner will be described later.

The number average particle diameter of the primary particle of the fine particle B is preferably 5 nm to 50 nm from the point that the effects of the present disclosure are caused to last longer. If the number average particle diameter falls within the above-described range, it becomes easier to curb fogging in an environment at a normal temperature and a normal humidity and an environment at a low temperature and a low humidity.

The number average particle diameter of the primary particle of the fine particle B is more preferably 10 nm to 50 nm and is further preferably 15 nm to 50 nm.

The number average particle diameter of the primary particle of the fine particle B can be adjusted by changing the firing temperature when the fine particle B is obtained, for example. A method of measuring the number average particle diameter of the primary particle of the fine particle B will be described later.

The dispersion degree evaluation index of the fine particle B is preferably 0.4 or less. If the dispersion degree evaluation index falls within the above-described range, it becomes easy to curb fogging in an environment at a normal temperature and a normal humidity and an environment at a low temperature and a low humidity, to curb a decrease in density in an environment at a low temperature and a low humidity, and to curb image flow. The dispersion degree evaluation index represents uniformity of external addition of the fine particle B, and a smaller value means that the external additive of the fine particle B is more uniform.

Specifically, the dispersion degree evaluation index of the fine particle B is measured by the following procedure. In other words, the surface of the toner is observed using a scanning electron microscope, energy dispersion type X-ray spectroscopy (EDX) analysis is performed, and binary processing is performed such that only the fine particle B on the surface of the toner is extracted. Then, the number of fine particles B and coordinates of centers of gravity of the fine particle B are calculated in the obtained image, and the distance dnₘᵢₙ between each fine particle B and the nearest fine particle B is calculated. The dispersion degree evaluation index for one toner is calculated using the following equation, where dₐᵥₑ is an arithmetic mean value of dnₘᵢₙ obtained.

$$( Dispersion degree evaluation index ) = \sqrt{\frac{{\sum }_{1}^{n} {( d {n}_{min} - {d}_{a v e} )}^{2}}{n}} / {d}_{a ν e}$$

The above measurement is performed for 50 toners while avoiding being arbitrary, and the arithmetic mean value of the obtained values is defined as the dispersion degree evaluation index of the fine particle B. A more specific measurement method will be described later.

The lower limit of the dispersion degree evaluation index of the fine particle B is not particularly limited, and the dispersion degree evaluation index of the fine particle B may be 0.0 to 0.4 or may be 0.1 to 0.4.

The dispersion degree evaluation index of the fine particle B can be adjusted by external addition conditions such as power and time of external addition.

### Method of Producing Toner

The method of producing a toner is not particularly limited, and a known method such as a pulverization method, a suspension polymerization method, a dissolution suspension method, an emulsion aggregation method, or a dispersion polymerization method can be used. The emulsion aggregation method is preferable in view of easiness of introduction of the crystalline polyester resin and formation of the core-shell structure.

### Emulsion Aggregation Method

The emulsion aggregation method is a method in which an aqueous fine particle dispersion that is formed of a constituent material of a toner particle and sufficiently small in relation to a target particle diameter is prepared in advance, the fine particles thereof are aggregated in an aqueous medium until the diameter reaches a particle diameter of the toner particle, and a resin is fused by heating or the like to produce a toner particle.

In other words, the following processes, for example, are performed to produce the toner particle in the emulsion aggregation method. The toner particle is produced through a dispersion process of preparing a fine particle dispersion composed of a constituent material of a toner particle, an aggregation process of aggregating fine particles composed of a constituent material of the toner particle and controlling a particle diameter until the particle diameter of the toner particle is obtained, a fusion process of subjecting a resin contained in the obtained aggregated particle for melt adhesion, a spheroidizing process of melting the toner particle by heating or the like and controlling a surface profile of a toner as needed, a subsequent cooling process, a metal removal process of filtering the obtained toner and removing excessive polyvalent metal ions, a filtration and washing process of washing the toner particle with ion exchange water or the like, and a process of removing moisture of the washed toner particle and drying the toner particle.

### Process of Preparing Resin Fine Particle Dispersion (Dispersion Process)

The resin fine particle dispersion can be prepared by a known method, but the method is not limited thereto. Examples of the known method include an emulsion polymerization method, a self-emulsification method, a phase inversion emulsification method in which an aqueous medium is added to a resin solution dissolved in an organic solvent to emulsify the resin, and a forced emulsification method in which a resin is forcibly emulsified by a high-temperature treatment in an aqueous medium without using an organic solvent.

Specifically, a binder resin is dissolved in an organic solvent in which the binder resin can be dissolved, and a surfactant or a basic compound is added thereto as needed. At that time, when the binder resin is a crystalline resin having a melting point, the resin only needs to be heated to a temperature equal to or higher than the melting point and dissolved. Subsequently, an aqueous medium is slowly added to precipitate a resin fine particle while stirring with a homogenizer or the like. Thereafter, the solvent is removed by heating or reducing the pressure to prepare an aqueous dispersion of resin fine particles. As the organic solvent used to dissolve the resin, any organic solvent can be used as long as it can dissolve the resin, and it is preferable to use an organic solvent that forms a uniform phase with water such as toluene from the viewpoint of curbing the generation of coarse powder.

The surfactant that may be used in the emulsification is not particularly limited, and examples thereof include an anionic surfactant such as a sulfuric acid ester salt-based surfactant, a sulfonate-based surfactant, a carboxylate-based surfactant, a phosphoric acid ester-based surfactant, or a soap-based surfactant; a cationic surfactant such as an amine salt-based surfactant and a quaternary ammonium salt-based surfactant; and a nonionic surfactant such as a polyethylene glycol-based surfactant, an alkylphenol ethylene oxide adduct-based surfactant and a polyhydric alcohol-based surfactant. The surfactants may be used alone or in combination of at least two kinds thereof.

Examples of the basic compound that may be used in the dispersion process include an inorganic base such as sodium hydroxide and potassium hydroxide; and an organic base such as ammonia, triethylamine, trimethylamine, dimethylaminoethanol and diethylaminoethanol. The basic compounds may be used alone or in combination of at least two kinds thereof.

In addition, a 50% particle diameter (D50) on a volume basis of binder resin fine particles in the aqueous dispersion of the resin fine particles is preferably 0.05 μm to 1.00 μm, and more preferably 0.05 μm to 0.40 μm. By adjusting the 50% particle diameter (D50) on a volume basis to the above range, it is easy to obtain toner particles having a volume-average particle diameter of 3 μm to 10 μm, which is a preferable volume-average particle diameter of toner particles.

It should be noted that a dynamic light scattering particle size distribution analyzer Nanotrac UPA-EX150 (manufactured by Nikkiso Co., Ltd.) is used to measure the 50% particle diameter (D50) on a volume dispersion basis.

### Colorant Fine Particle Dispersion

A colorant fine particle dispersion may be used as needed. The colorant fine particle dispersion can be prepared by the following known method, but the method is not limited thereto. The colorant fine particle dispersion can be prepared by mixing a colorant, an aqueous medium, and a dispersing agent with a known mixing machine such as a stirrer, emulsifier, or disperser. As the dispersing agent used herein, a known dispersing agent such as a surfactant or a polymer dispersing agent may be used.

Although both the dispersing agents, namely the surfactant and the polymer dispersing agent can be removed in a washing process, which will be described later, the surfactant is preferable from the viewpoint of washing efficiency.

Examples of the surfactant include an anionic surfactant such as a sulfuric acid ester salt-based surfactant, a sulfonate salt-based surfactant, a phosphate ester-based surfactant and a soap-based surfactant; a cationic surfactant such as an amine salt-based surfactant and a quaternary ammonium salt-based surfactant; and a nonionic surfactant such as a polyethylene glycol-based surfactant, an alkylphenol ethylene oxide adduct-based surfactant and a polyhydric alcohol-based surfactant. Among them, a nonionic surfactant or an anionic surfactant is preferable. A nonionic surfactant and an anionic surfactant may be used in combination. The surfactants may be used alone or in combination of at least two kinds thereof. The concentration of the surfactant in the aqueous medium is preferably 0.5% by mass to 5% by mass.

The content of the colorant fine particles in the colorant fine particle dispersion is not particularly limited, and is preferably 1% by mass to 30% by mass relative to the total mass of the colorant fine particle dispersion.

In addition, it is preferable that a dispersion particle diameter of the colorant fine particles in the aqueous dispersion of the colorant have a 50% particle diameter (D50) on a volume basis of not more than 0.5 μm from the viewpoint of the dispersibility of the colorant in the finally obtained toner. In addition, for the same reason, a 90% particle diameter (D90) on a volume basis is preferably not more than 2 μm. Note that the dispersion particle diameter of the colorant fine particles dispersed in the aqueous medium is measured with a dynamic light scattering particle size distribution analyzer (Nanotrac UPA-EX150: manufactured by Nikkiso Co., Ltd.).

Examples of the known mixing machine such as a stirrer, emulsifier, or disperser used when dispersing the colorant in the aqueous medium include an ultrasonic homogenizer, a jet mill, a pressure type homogenizer, a colloid mill, a ball mill, a sand mill, and a paint shaker. These mixing machines may be used alone or in combination.

### Release Agent (Aliphatic Hydrocarbon) Fine Particle Dispersion

A release agent fine particle dispersion may be used as needed. The release agent fine particle dispersion can be prepared by the following known methods, but is not limited to these methods.

The release agent fine particle dispersion can be produced by adding a release agent to an aqueous medium containing a surfactant, heating the resulting mixture to a temperature equal to or higher than the melting point of the release agent, and dispersing the mixture in the form of particle with a homogenizer (for example, “CLEARMIX W Motion” manufactured by M Technique Co., Ltd.) or a pressure discharge type disperser (for example, “Gaulin homogenizer” manufactured by Gaulin Corporation) having a strong shearing ability. It may also be cooled to below the melting point of the release agent as needed.

The dispersion particle diameter of the release agent fine particle dispersion in the release agent aqueous dispersion is preferably, as a 50% particle diameter (D50) on a volume distribution basis, 0.03 μm to 1.0 μm and more preferably 0.1 μm to 0.5 μm. It is preferable that a coarse particle of at least 1 μm be not present.

It is possible to cause the release agent to be present in a finely distributed state, to cause an outmigration effect at the time of fixing to be expressed to the maximum extent, and to obtain satisfactory separability. Note that the dispersion particle diameter of the release agent fine particle dispersion dispersed in the aqueous medium can be measured by a dynamic light scattering particle size distribution analyzer (Nanotrac UPA-EX150: manufactured by Nikkiso Co., Ltd.).

### Mixing Process

In the mixing process, a mixed liquid obtained by mixing the resin fine particle dispersion, and as necessary, at least one of the release agent fine particle dispersion and the colorant fine particle dispersion is prepared. The mixing process can be performed using a known mixing machine such as a homogenizer or a mixer.

### Process of Forming Aggregate Particles (Aggregation Process)

In the aggregation process, fine particles contained in the mixed solution prepared in the mixing process are aggregated to form an aggregate having a target particle diameter. In this case, a flocculant is added and mixed, and at least one of the heating and mechanical power is applied as necessary and as appropriate to form an aggregate obtained by aggregating resin fine particle, and, if necessary, at least one of a release agent fine particle and a colorant fine particle.

Examples of the flocculant include an organic flocculant such as a cationic surfactant of a quaternary salt and polyethyleneimine; an inorganic metal salt such as sodium sulfate, sodium nitrate, sodium chloride, calcium chloride and calcium nitrate; an inorganic ammonium salt such as ammonium sulfate, ammonium chloride and ammonium nitrate; and an inorganic flocculant such as a divalent or higher metal complex. In addition, it is also possible to add an acid so as to cause soft aggregation by lowering the pH, and for example, sulfuric acid, nitric acid, or the like can be used.

The flocculant may be added in the form of either a dry powder or an aqueous solution dissolved in an aqueous medium, and in order to cause uniform aggregation, it is preferable to add the flocculant in the form of an aqueous solution. In addition, the addition and mixing of the flocculant are preferably performed at a temperature equal to or lower than a glass transition temperature or a melting point of the resin contained in the mixed solution. By performing mixing under these temperature conditions, aggregation proceeds relatively uniformly. The flocculant can be mixed into the mixed solution using a known mixing device such as a homogenizer or a mixer. The aggregation process is a process of forming an aggregate having a toner particle diameter in an aqueous medium. A volume-average particle diameter of the aggregates produced in the aggregation process is preferably 3 μm to 10 μm. The volume-average particle diameter can be measured using a particle size distribution analyzer (Coulter Multisizer III, manufactured by Beckman Coulter, Inc.) using the Coulter method.

### Process of Obtaining Dispersion Containing Toner Particles (Fusion Process)

In the fusion process, the dispersion containing the aggregate obtained in the aggregation process is first subjected to a stop of aggregation under stirring similar to the aggregation process. The aggregation is terminated by adding an aggregation terminating agent such as a base that can adjust a pH, a chelate compound, or an inorganic salt compound such as sodium chloride.

After the dispersion state of the aggregated particles in the dispersion becomes stable by the action of the aggregation terminating agent, the dispersion is heated to a temperature equal to or higher than the glass transition temperature or melting point of the binder resin, and the aggregated particles are fused to adjust the particle diameter to a desired particle diameter. Note that it is preferable that the 50% particle diameter (D50) on a volume basis of the toner particles be 3 μm to 10 μm.

### Post-Treatment Process

In the method of producing the toner, a post-treatment process such as a washing process, a solid-liquid separation process, or a drying process may be further performed, and a toner particle in a dried state is obtained by performing the post-treatment process.

### External Addition Process

In order to embed the fine particle B in the surface of the toner particle, it is preferable to warm an external adding device and to embed the fine particle B by heat in the external addition process, that is, in the process of mixing the toner particle and the fine particle B. It is possible to embed the fine particle B by imparting a mechanical impact force to the surface of the toner particle slightly softened by the heat. Alternatively, production may be performed by a method of mixing the toner particle with the fine particle B in the external addition process, then providing a warming process using another device, and embedding the fine particle B.

In order to achieve desired embedding of the fine particle B, it is preferable to set the temperature of the external addition process near the glass transition temperature Tg of the toner particle. Specifically, the temperature TB (° C.) of the external addition process of the fine particle B preferably satisfies the condition of Tg−10 (° C.)≤TB≤Tg+5 (° C.) and more preferably satisfies Tg−10 (° C.)≤TB≤Tg where the glass transition temperature of the toner particle is defined as Tg (° C.).

Also, the glass transition temperature Tg of the toner particle is preferably 40° C. to 70° C. and is more preferably 50° C. to 60° C. from the viewpoint of storability.

As an apparatus used in the external addition process of the fine particle B, an apparatus having a mixing function and a function of imparting a mechanical impact force is preferable, and a known mixing apparatus can be used. For example, it is possible to embed the fine particle B in the toner particle warming and using a known mixing machine such as an FM mixer (manufactured by Nippon Coke & Engineering Company, Limited), a super mixer (manufactured by Kawata Co., Ltd), or a hybridizer (manufactured by Nara Machinery), or the like.

The fine particle B and the fine particle A may be added to the surface of the toner particle in the above-described external addition process, or it is preferable that the external addition process be divided into two stages and an external addition process of externally adding the fine particle B and an external addition process of external adding the fine particle A be provided. For example, it is preferable to perform the external addition process of the fine particle A after the external addition of the fine particle B, and the temperature TA (° C.) of the external addition process of the fine particle A is preferably set to satisfy TA≤Tg−15 (° C.), and is more preferably set to satisfy Tg−40 (° C.)≤TA≤Tg−25 (° C.) with respect to the glass transition temperature Tg (° C.) of the toner particle. If the temperature TA (° C.) falls within the above-described range, it becomes easy to provide the fine particle A on the surface of the toner particle while causing the embedding rate of the fine particle B to fall within the above-described range.

Although the weight average particle diameter Y (μm) of the toner is not particularly limited, the weight average particle diameter Y (μm) may be 3.0 μm to 10.0 μm. The value of Y can be varied by adjusting conditions when the toner particle is produced, for example, the temperature and the time in the fusion process. A method of measuring the weight average particle diameter of the toner will be described later.

Next, a method of measuring each physical property according to the present disclosure will be described.

### Measurement of Weight-Average Particle Diameter (D4) and Number Average Particle Diameter (D1) of Toner or Toner Particles

A weight-average particle diameter (D4) and a number-average particle diameter (D1) of the toner or the toner particles are measured with 25,000 effective measurement channels using a precision particle size distribution measuring device “Coulter Counter Multisizer 3” (registered trademark, manufactured by Beckman Coulter, Inc.) by a pore electrical resistance method provided with an aperture tube of 100 μm and a dedicated software “Beckman Coulter Multisizer 3 Version 3.51” (manufactured by Beckman Coulter, Inc.) attached for setting measurement conditions and analyzing measurement data, and the measurement data is analyzed and calculated.

As an electrolyte aqueous solution used for the measurement, a solution prepared by dissolving special grade sodium chloride in ion exchange water to a concentration of about 1% by mass, for example, “ISOTON II” (commercially available from Beckman Coulter, Inc.) can be used.

Before the measurement and the analysis, the dedicated software is set as described below.

On the “standard measurement method (SOM) change screen” of the dedicated software, the total count number in the control mode is set to 50,000 particles, the number of times of measurements is set to one, and the Kd value is set to a value obtained using “standard particle 10.0 μm” (manufactured by Beckman Coulter, Inc.). When the threshold/noise level measurement button is pressed, the threshold and the noise level are automatically set. In addition, the current is set to 1,600 μA, the gain is set to 2, the electrolyte solution is set to ISOTON II, and the box “flush aperture tube after measurement” is checked.

In the “Setting screen for converting pulse to particle diameter” in the dedicated software, set the bin interval to the logarithmic particle diameter, set the particle diameter bin to 256 particle diameter bin, and set the particle diameter range to from 2 μm to 60 μm.

The specific measurement method is as follows.

(1) 200 ml of lectrolyte aqueous solution described above is put into a 250 ml round-bottom glass beaker dedicated to Multisizer 3, which is set on a sample stand, and stirring rods are stirred counterclockwise at 24 rotations/sec. Then, contaminants and air bubbles in the aperture tube are removed by the function “flush aperture tube” in the dedicated software.

(2) The aqueous electrolytic solution: 30 ml is put into a 100 ml flat-bottom glass beaker. To this solution, 0.3 ml of a diluted solution prepared by diluting “Contaminon N” (a 10% by mass aqueous solution of a neutral detergent with pH 7 for washing precision measurement instruments, including a nonionic surfactant, an anionic surfactant, and an organic builder, manufactured by Wako Pure Chemical Industries, Ltd.) with ion exchange water to 3 times by mass is added as a dispersing agent.

(3) Two oscillators with an oscillating frequency of 50 kHz and with phases shifted by 180 degrees are incorporated, a predetermined amount of ion exchange water is put into a water tank of an ultrasonic disperser “Ultrasonic Dispersion System Tetoral50” with an electrical output of 120 W (commercially available from Nikkaki Bios Co., Ltd.), and about 2 ml of Contaminon N described above is added to this water tank.

(4) The beaker in (2) is set in a beaker fixing hole of the ultrasonic disperser, and the ultrasonic disperser is operated. The height position of the beaker is adjusted so that the resonance state of the liquid level of the electrolyte aqueous solution in the beaker is maximized.

(5) While the electrolyte aqueous solution in the beaker in (4) is irradiated with ultrasonic waves, 10 mg of the toner or toner particles are added little by little to the electrolyte aqueous solution and dispersed. Then, the ultrasonic dispersion treatment is further continued for 60 seconds. Upon the ultrasonic dispersion, the water temperature in the water tank is appropriately adjusted from 10° C. to 40° C.

(6) The electrolyte aqueous solution in (5) in which the toner or toner particles are dispersed is added dropwise to the round bottom beaker in (1) installed in a sample stand using a pipette, and a measurement concentration is adjusted to 5%. Then, the measurement is performed until the number of measurement particles reaches 50,000.

(7) The measurement data is analyzed with the dedicated software attached to the device to calculate the weight average particle diameter (D4). The “average diameter” on the analysis/volume statistical value (arithmetic average) screen at the time of setting graph/% by volume with the dedicated software is the weight average particle diameter (D4), and the “average diameter” on the “analysis/number statistical value (arithmetic average)” screen at the time of setting graph/% by number with the dedicated software is the number average particle diameter (D1).

### Method of Identifying Organosilicon Polymer Particle (Fine Particle A)

A pyrolysis gas chromatography mass spectrometry (hereinafter, also referred to as a pyrolysis GC/MS) and NMR are used to identify the compositions and the ratios of constituent compounds of the organosilicon polymer particle contained in the toner. Note that in a case where the organosilicon polymer particle can be obtained alone, it is also possible to measure the organosilicon polymer particle alone.

In a case where the organosilicon polymer is extracted from the toner, it is possible to disperse the toner with a dispersing medium, the organosilicon polymer can be isolated by centrifugation using a difference in specific gravity after dispersing the toner in a dispersing medium and liberating the fine particle A using an ultrasonic homogenizer. As the dispersing medium, it is possible to use a solution obtained by dissolving sucrose (manufactured by Kishida Chemical Co., Ltd.) in ion exchange water, for example. It is possible to prepare the external additives at an arbitrary specific gravity within a range that enables the separation by changing the concentration of sucrose. At this time, ultrasonic waves are applied while cooling the vial with ice water so that the temperature of the dispersion should not rise.

Pyrolysis GC/MS is used to analyze the type of the constituent compounds of the organosilicon polymer particles.

The types of the constituent compounds of the organosilicon polymer particle are identified by analyzing the mass spectrum of components of a degradation product corresponding to the organosilicon polymer particle that are generated when the toner is thermally degraded at 550° C. to 700° C. Specific measurement methods are as follows.
Measurement Conditions of Pyrolysis GC/MS
Pyrolysis apparatus: JPS-700 (Japan Analytical Industry)
Degradation temperature: 590° C.
GC/MS apparatus: Focus GC/ISQ (Thermo Fisher)
Column: HP-5MS with a length of 60 μm, an inner diameter of 0.25 mm, and a film thickness of 0.25 m
Inlet temperature: 200° C.
Flow pressure: 100 kPa
Split: 50 mL/min
MS ionization: EI
Ion source temperature: 200° C. Mass Range 45 to 650

Subsequently, the abundance ratios of the identified constituent compounds of the organosilicon polymer particle are measured and calculated by solid ²⁹Si-NMR.

In the solid ²⁹Si-NMR, peaks are detected in different shift regions due to the structure of a functional group that is bonded to Si of the constituent compounds of the organosilicon polymer particle.

A structure that is bonded to Si is specified by specifying each peak position using a standard sample. In addition, the abundance amount ratio of each constituent compound is calculated from obtained peak areas. The proportion of the peak areas with a T3 unit structure with respect to the total peak area is obtained by calculation.

Measurement conditions for the solid ²⁹Si-NMR are as follows.
Apparatus JNM-ECX5002 (JEOL RESONANCE)
Temperature: Room temperature
Measurement method: DDMAS method 29Si 450
Specimen tube: Zirconia 3.2 mmφ
Sample: Loaded into a test tube in a powder form
Specimen rotation speed: 10 kHz
Relaxation delay: 180 s
Scan: 2000

### Amount of Toluene-Soluble Matter of Fine Particle A

The fine particle A isolated from the toner by the above-described method is dissolved in toluene. The toluene-soluble matter is isolated by centrifugation, and the percentage by mass of the total soluble matter with respect to the fine particle A is calculated from the dry weight after solvent removal. On the other hand, the resulting solution is filtered through a solvent-resistant membrane filter “Maeshori Disc” (manufactured by Tosoh Corporation) with a pore diameter of 0.2 μm to thereby obtain this sample solution, and GPC measurement is performed under the following conditions.

### Apparatus: High-Speed GPC Apparatus “HLC-8220GPC” [Manufactured by Tosoh Corporation]

Column: LF-604 tandem [manufactured by Showa Denko]
Eluent: Toluene
Flow rate: 0.6 mL/min
Oven temperature: 40° C.
Sample injection amount: 0.020 mL

In the calculation of the molecular weight of the sample, a molecular weight calibration curve created using a standard polystyrene resin (trade name “TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used. The rate of the areas having molecular weights in a range of 1,000 to 10,000 with respect to the total peak area is calculated, the rate is multiplied by the percentage by mass of the above-described total soluble matter with respect to the fine particle A to thereby calculate the content of toluene-soluble matter having a molecular weight of 1,000 to 10,000 with respect to the fine particle A.

### Method of Measuring Volume Resistivity of Fine Particle B

The volume resistivity of the fine particle B is calculated from a current value measured using an electrometer (sub-femtoampere remote source meter, Model 6430, manufactured by Keithley Instruments). A sample holder (model SH2-Z manufactured by Toyo Corporation) of a vertical electrode sandwiching type is filled with 1.0 g of fine particle B, and the fine particle B is compressed by applying a torque of 2.0 N m. As electrodes, an upper electrode with a diameter of 25 mm and a lower electrode with a diameter of 2.5 mm are used. A voltage of 10.0 V is applied to the external additives through the sample holder, a resistance value is calculated from a current value at the time of saturation that does not include a charge current, and volume resistivity is calculated by the following expression.

A method of isolating the fine particle B from the toner is as follows. In other words, the toner is dispersed in a solvent such as chloroform, and thereafter, the fine particle B can be isolated with differences in specific gravity through centrifugation or the like. Note that in a case where it is possible to obtain the fine particle B alone, it is also possible to measure the fine particle B alone.

$$Volume resistivity ( Ω \cdot m ) = resistance ( Ω ) \cdot electrode area ( {m}^{2} ) / sample thickness ( m )$$

### Method of Measuring Content of Fine Particle B

The fine particle B is isolated from the toner by the method described in the above section of the method of measuring the volume resistivity of the fine particle B. The isolated fine particle B is used as a sample, and the sample and the toner are subjected to fluorescent X-ray measurement, respectively. The content of fine particle B with respect to 100 parts by mass of toner particle is obtained from an intensity ratio of the peak corresponding to the fine particle B obtained in the fluorescent X-ray measurement.

### Method of Measuring Number Average Particle Diameters of Primary Particles of Fine Particle a and Fine Particle B

The number average particle diameters of the primary particles of the fine particle A and the fine particle B are measured using a scanning electron microscope “S-4800” (trade name: manufactured by Hitachi, Ltd.). The toner to which the fine particle A has been added is observed, the major diameters of the primary particles of 100 fine particles A are randomly measured while avoiding being arbitrary in the field of view enlarged to 50,000 times at maximum, and the number average particle diameter is obtained. The observation magnification is appropriately adjusted depending on the size of the fine particles A. At this time, energy dispersion type X-ray spectroscopy (EDX) analysis is performed to determine whether or not the particles are the fine particles A. In a case where an element corresponding to the fine particles A is detected, it is determined that the observed fine particles are the fine particles A.

In a case where it is possible to obtain the fine particle A alone, it is also possible to measure the fine particle A alone. The number average particle diameter of the fine particle B is also obtained by a similar method. In a case where an element corresponding to the fine particle B is detected in EDX analysis, it is determined that the observed fine particles are the fine particles B.

### Dispersion Degree Evaluation Index of Fine Particle B on Surface of Toner

The dispersion degree evaluation index of the fine particles B on the surface of the toner is calculated using a scanning electron microscope “S-4800”. The toner with the fine particles B externally added is observed in the field of view enlarged to 10,000 times at an acceleration voltage of 1.0 kV in the same field of view. Image processing software “ImageJ” (available in https://imagej.nih.gov/ij/) is used on the observed image, and calculation is performed as follows.

Binary processing is performed such that only the fine particles B are extracted. Specifically, the surface of the toner in the same field of view is observed, and energy dispersion type X-ray spectroscopy (EDX) analysis is performed to determine whether or not the particles are the fine particles B. In a case where an element corresponding to the fine particles B is detected, it is determined that the particles are the fine particles B. The number n of the fine particles B is calculated, the coordinates of centers of gravity of all the fine particles B are calculated, and the distance dnₘᵢₙ between each fine particle B and the closest fine particle B is calculated. The dispersion degree evaluation index of one toner is calculated using the following expression on the assumption that an arithmetic mean value of the closest distance between the fine particles B in the image is dₐᵥₑ.

$$( Dispersion degree evaluation index ) = \sqrt{\frac{{\sum }_{1}^{n} {( d {n}_{min} - {d}_{a v e} )}^{2}}{n}} / {d}_{a ν e}$$

The dispersion degrees of 50 toners randomly observed while avoiding being arbitrary are obtained by the above-described procedure, and an arithmetic mean value thereof is defined as the dispersion degree evaluation index.

### Method of Calculating Embedding Rate B1/(B1+B2)×100 of Fine Particle B

Hereinafter, a case where the fine particle B is titanium oxide will be described below as an example. The area of the titanium oxide particle that is present on the contour of the section of the toner particle and within 30 nm from the contour of the toner particle is calculated using a scanning transmission electron microscope (STEM).

The section of the toner that is observed with the scanning transmission electron microscope (STEM) is produced as follows.

Hereinafter, a procedure for producing the cross section of the toner will be described.

First, in order to produce the section of the toner, mixed powder of an embedding resin and the toner is produced. As the resin for embedding the toner, a resin containing a metal element not contained in the toner is selected. Although the resin containing a metal element that is not contained in the toner is not particularly limited as long as it has moderate deformability at the room temperature, long-chain fatty acid metal salts can be suitably used. Among the long-chain fatty acid metal salts, zinc stearate or magnesium stearate having relatively low melting points can be more suitably used.

100 parts by mass of the embedding resin is weighed with respect to 1 part by mass of toner and is put into a sample bottle. Next, the previous sample bottle is shaken at 500 rpm for 30 minutes to produce mixed powder of the toner and the embedding resin. A case where zinc stearate is used as the embedding resin will be described below.

Next, the mixed powder is pressurized at 20 Pa for 10 minutes to produce a pellet-like press-molded piece (hereinafter, referred to as a pellet).

The pellet is cut at a cutting speed of 0.6 mm/s with an ultra-microtome (Leica, UC7) to produce the section of the toner.

Next, the toner is cut to have a film thickness of 500 nm to produce a thin sample of the section of the toner. It is possible to obtain the section of the toner by cutting the toner by such a method.

The section of the toner is observed at an acceleration voltage of 100 kV using JEM-2800 (manufactured by JEOL Ltd.). A clear image is acquired with a STEM probe size of 1 nm and an image size of 512 pixels×512 pixels. The image magnification is 100,000 times, and the image is acquired such that at least about ¼ or more the circumference of the section of one toner particle falls within the image.

Also, the section of the toner, an image of which is to be acquired, is selected such that the section has a major diameter of 0.9 to 1.1 times the number average particle diameter (D1) of the toner.

In parallel with the above-described shape image acquisition, mapping analysis of elements contained in the observation image is performed using an energy dispersive X-ray spectrometer (EDS). As the elements to be measured, elements contained in the toner and the embedding resin are selected just in the right amount. The analysis is performed with mapping resolution of 256 pixels×256 pixels and 0.01 m/pixel.

The total area of titanium oxide particle that is present on the contour of the section of the toner particle and within 30 nm from the contour of the section of the toner particle is derived by performing image analysis on the image obtained by the above-described element analysis using the image processing software ImageJ.

Since the cut film thickness of 500 nm is sufficiently thin relative to an ordinary toner, a region where a metal element (zinc element) contained only in the embedding resin can be determined to be outside of the toner. On the other hand, since the external additive is usually smaller than the film thickness of 500 nm, a region that is present inside the toner and a region that is present outside the toner and is included in the embedding resin are detected, respectively, as in the Figure.

In other words, both the metal element and the element of the external additive contained only in the embedding resin are detected in the external additive region that is present outside the contour of the section of the toner particle. On the other hand, the element of the external additive is detected while the metal element contained only in the embedding resin is not detected in the external additive that is present on the contour of the section of the toner particle and within the contour of the section of the toner particle.

Using the above method, the total area B1 (pixel) of titanium oxide (fine particle B) that is present on the contour of the section of the toner particle and within 30 nm from the contour of the section of the toner particle can be defined as follows.

B1 (pixel)=“the number of pixels that are present in a region, in which a titanium element is detected, the metal element contained only in the embedding resin is not detected, which is present within 30 nm from the contour of the section of the toner particle toward the center of gravity (geometric center) of the toner particle”

Measurement of whether the distance from the contour of the section of the toner particle is within 30 nm can be performed by the following procedure using ImageJ. First, an element mapping image of the metal element contained only in the embedding resin is opened in ImageJ. Next, a scale length of 1 pixel on the image is set. In a case where a scale bar is displayed on the image, it is possible to set a scale length on the image by a Set Scale on an Analyze tab with the image caused to overlap on a Straight Line on a Straight tab.

Next, 8 bits are selected in Type on Image tab, the image is converted to a monochromatic image, and smoothing is performed thereon using Smooth on the Process tab. Then, the image is binarized by opening Threshold of Adjust on Image tab to obtain a binary image. As binary conditions, Default is selected. Through this procedure, it is possible to distinguish the region where the metal element contained only in the embedding resin is detected and the region where the metal element is not detected. The obtained binarized image and the STEM shape image are caused to overlap, a line segment corresponding to 30 nm is depicted with Straight Line on Straight tab from the contour of the section of the toner particle toward the center of gravity (geometric center), to thereby measure whether the distance from the contour of the section of the toner particle is within 30 nm.

The total area B2 (pixel) of the titanium oxide particle (fine particle B) that is present outside the contour of the section of the toner particle can be defined as follows.

$$B 2 ( pixel ) = “ the number of pixels from which both a titanium element and the metal element contained only in the embedding resin are detected ”$$

Through the above procedure, the total area B1 (pixel) of the titanium oxide particle that is present on the contour of the section of the toner particle and within 30 nm from the contour of the toner particle and the total area B2 (pixel) of the titanium oxide particle that is present outside the contour of the section are calculated, and the value of B1/(B1+B2)×100 is then calculated. Note that the above procedure is performed for 50 fields of view, and an arithmetic mean value of the value of B1/(B1+B2)×100 in each field of view is employed as the value of B1/(B1+B2) in the toner. Also, a standard deviation of B1/(B1+B2) in 50 fields of view is defined as the standard deviation C.

### EXAMPLES

Hereinafter, the present disclosure will be further specifically described on the basis of examples. The present disclosure is not limited to the following examples. Note that unless otherwise particularly specified, “part(s)” in the formulation of this document are on a mass basis.

### Synthesis of Polyester Resin 1

Bisphenol A ethylene oxide 2 mol adduct: 9 parts by mole
Bisphenol A propylene oxide 2 mol adduct: 95 parts by mole
Terephthalic acid: 50 parts by mol
Fumaric acid: 30 parts by mol
n-dodecenylsuccinic acid: 25 parts by mol

The above-described monomers were added to a flask equipped with a stirring device, a nitrogen inlet tube, a temperature sensor, and a rectifying column, the temperature was raised to 195° C. over 1 hour, and uniform stirring in the reaction system was confirmed. To a total of 100 parts of these monomers, 1.0 part of tin distearate was added. The temperature was further raised from 195° C. to 250° C. over 5 hours while generated water was distilled off, and a dehydration condensation reaction was further performed at 250° C. for 2 hours.

As a result, a polyester resin 1 having a glass transition temperature of 60.2° C., an acid value of 16.8 mgKOH/g, a hydroxyl value of 28.2 mgKOH/g, a weight average molecular weight of 11200, and a number average molecular weight of 4100 was obtained.

### Synthesis of Polyester Resin 2

Bisphenol A ethylene oxide 2 mol adduct: 48 parts by mole
Bisphenol A propylene oxide 2 mol adduct: 48 parts by mole
Terephthalic acid: 65 parts by mol
n-dodecenylsuccinic acid: 30 parts by mol

The above-described monomers were added to a flask equipped with a stirring device, a nitrogen inlet tube, a temperature sensor, and a rectification column, the temperature was raised to 195° C. over 1 hour, and uniform stirring in the reaction system was confirmed. To a total of 100 parts of these monomers, 0.7 part of tin distearate was added. The temperature was further raised from 195° C. to 240° C. over 5 hours while generated water was distilled off, and a dehydration condensation reaction was further performed at 240° C. for 2 hours.

Next, the temperature was lowered to 190° C., 5 parts by mole of trimellitic anhydride was gradually added, and the reaction was continued at 190° C. for 1 hour.

As a result, a polyester resin 2 having a glass transition temperature of 55.2° C., an acid value of 14.3 mg KOH/g, a hydroxyl value of 24.1 mg KOH/g, a weight average molecular weight of 43600, and a number average molecular weight of 6200 was obtained.

### Production Example of Crystalline Polyester Resin 1

1,9-nonanediol: 30 parts by mole
1,10-decanedicarboxylic acid: 35 parts by mole

The above-described alcohol monomer and acid monomer were added to a flask equipped with a stirring device, a nitrogen inlet tube, a temperature sensor, and a rectification column, the temperature was raised to 150° C. over 1 hour, and uniform stirring in the reaction system was confirmed. To a total of 100 parts of these monomers, 0.7 parts of tin distearate was added. The temperature was raised from 150° C. to 180° C. over 5 hours while generated water was distilled off, and the reaction was further caused at 180° C. at 1 hPa to thereby obtain a crystalline polyester resin 1 having a weight average molecular weight of 20,000.

### Production Example of Crystalline Polyester Resins 2 and 3

Crystalline polyester resins 2 and 3 were obtained by a method similar to the that in the production example of the crystalline polyester resin 1 other than that the types of alcohol monomer and acid monomer were changed as described in Table 2. Physical properties are shown in Table 1.

TABLE 1

| | | | Weight |
|---|---|---|---|
| | | | average |
| | | | molecular |
| | Alcohol monomer | Acid monomer | weight |
| Crystalline | 1,9-nonanediol | 1,10-decanedicarboxylic | 20000 |
| polyester | | acid | |
| resin 1 | | | |
| Crystalline | 1,6-hexanediol | 1,10-decanedicarboxylic | 20000 |
| polyester | | acid | |
| resin 2 | | | |
| Crystalline | 1,12-dodecanediol | 1,8-octanedicarboxylic | 20000 |
| polyester | | acid | |
| resin 3 | | | |

### Preparation of Resin Particle Dispersion 1

Polyester resin 1: 100 parts
Methyl ethyl ketone: 50 parts
Isopropyl alcohol: 20 parts

The vessel was charged with the above methyl ethyl ketone and isopropyl alcohol. Thereafter, the above-described polyester resin 1 was gradually input, was stirred, and was completely dissolved to thereby obtain a polyester resin 1 solution. The container with the polyester resin 1 solution contained therein was set to 65° C., and a 10% aqueous ammonia solution was gradually added dropwise with stirring to a total of 5 parts, and 230 parts of ion exchange water was gradually added dropwise at a speed of 10 ml/min, to cause phase-transfer emulsification. Furthermore, desolvation was performed with an evaporator under a reduced pressure to thereby obtain a resin particle dispersion 1 of the polyester resin 1. The volume average particle diameter of the resin particle was 135 nm. In addition, the resin particle solid content was adjusted to 20% using ion exchange water.

### Preparation of Resin Particle Dispersion 2

Polyester resin 2: 100 parts
Methyl ethyl ketone: 50 parts
Isopropyl alcohol: 20 parts

The vessel was charged with the above methyl ethyl ketone and isopropyl alcohol. Thereafter, the above-described polyester resin 2 was gradually input, was stirred, and was completely dissolved to thereby obtain a polyester resin 2 solution. The container with the polyester resin 2 solution contained therein was set to 40° C., and a 10% aqueous ammonia solution was gradually added dropwise with stirring to a total of 3.5 parts, and 230 parts of ion exchange water was gradually added dropwise at a speed of 10 ml/min, to cause phase-transfer emulsification. Furthermore, desolvation was performed with an evaporator under a reduced pressure to thereby obtain a resin particle dispersion 2 of the polyester resin 2. The volume average particle diameter of the resin particle was 155 nm. In addition, the resin particle solid content was adjusted to 20% using ion exchange water.

### Preparation of Colorant Particle Dispersion

Copper phthalocyanine (Pigment Blue 15:3): 45 parts
Ionic surfactant (trade name: Neogen RK, manufactured by DKS CO. Ltd.): 5 parts
Ion exchange water: 190 parts

The above components were mixed and dispersed using a homogenizer (ULTRA-TURRAX manufactured by IKA) for 10 minutes. Thereafter, dispersion treatment was performed for 20 minutes at a pressure of 250 MPa using an ultimizer (counter-collision type wet grinding machine manufactured by Sugino Machine Ltd.) to obtain a colorant particle dispersion in which the voltage average particle diameter of the colorant particle was 120 nm and the solid content was 20%.

### Preparation of Release Agent Particle Dispersion

Release agent (hydrocarbon wax, melting point: 79° C.): 15 parts
Ionic surfactant (trade name: Neogen RK, manufactured by DKS CO. Ltd.): 2 parts
Ion exchange water: 240 parts

The above components were mixed and heated to 100° C. and dispersed sufficiently in Ultra-Turrax T50 manufactured by IKA. After that, the mixture was warmed to 115° C. with a pressure-discharge type Gaulin homogenizer to perform dispersion treatment for 1 hour to obtain a release agent particle dispersion with a volume-average particle diameter of 160 nm and a solid content of 20%.

### Preparation of Crystalline Polyester Resin Dispersion 1

Crystalline polyester resin 1: 15 parts
Ionic surfactant (trade name: Neogen RK, manufactured by DKS CO. Ltd.): 2 parts
Ion exchange water: 240 parts

The above components were mixed and heated to 100° C. and dispersed sufficiently in Ultra-Turrax T50 manufactured by IKA. Thereafter, the mixture was warmed to 115° C. with a pressure-discharge type Gaulin homogenizer to perform dispersion treatment for 1 hour to obtain a crystalline polyester resin dispersion 1 having a volume average particle diameter of 200 nm and solid content of 20%.

### Preparation of Crystalline Polyester Resin Dispersions 2 and 3

Crystalline polyester resin dispersions 2 and 3 having a volume average particle diameter of 200 nm and a solid content of 20% were obtained similarly to the preparation of the crystalline polyester resin dispersion 1 other than that the crystalline polyester resins 2 and 3 were used instead of the crystalline polyester resin 1.

### Production of Toner Particle 1

Resin particle dispersion 1: 500 parts
Resin particle dispersion 2: 400 parts
Crystalline polyester resin dispersion 1:80 parts
Colorant particle dispersion: 50 parts
Release agent particle dispersion: 80 parts

First, as a core formation process, each of the above-described materials was put into a round stainless flask and was mixed. Subsequently, the mixture was dispersed at 5,000 r/min for 10 minutes using a homogenizer ULTRA-TURRAX T50 (manufactured by IKA). A 1.0% nitric acid aqueous solution was added to adjust the pH to 3.0, and then the mixed solution was heated to 58° C. using a stirring blade in a water bath for heating while the number of revolutions was appropriately adjusted.

The volume average particle diameter of the formed aggregated particle was appropriately checked using a Coulter Multisizer III, and when an aggregated particle (core) of 4.5 μm was formed, each of the following materials was input and further stirred to thereby form a shell.
Resin particle dispersion 1: 40 parts
Ion exchange water: 300 parts
10.0% by mass of borax aqueous solution: 19 parts (Borax, sodium tetraborate decahydrate, manufactured by FUJIFILM Wako Pure Chemical Corporation)

Thereafter, a 5% sodium hydroxide aqueous solution was used to adjust pH to 9.0, and stirring was performed at 80° C. for 1 hour.

Thereafter, the mixture was cooled to 25° C., filtration and solid-liquid separation were performed, and washing was then performed with ion exchange water. After the washing, the mixture was dried using a vacuum drier, fine and rough powder was further cut using a multi-stage classifier using the Coanda effect, to thereby obtain a toner particle 1 having a weight average particle diameter (D4) of 6.0 μm. The physical properties of the toner 1 are shown in Table 2.

### Production of Toner Particles 2 to 6 and 8

Toner particles 2 to 6 and 8 were obtained by a method similar to that of the toner particle 1 other than that used crystalline polyester resin dispersions were changed and materials and particle diameters were changed to those shown in Table 2.

TABLE 2

| | Crystalline | | Particle | |
|---|---|---|---|---|
| | polyester | | diameter | Tg |
| Toner particle | resin | Shell | (μm) | (° C.) |
| Toner particle 1 | Crystalline | Polyester | 6.0 | 55 |
| | polyester resin 1 | resin 1 | | |
| Toner particle 2 | Crystalline | Polyester | 6.0 | 55 |
| | polyester resin 2 | resin 1 | | |
| Toner particle 3 | Crystalline | Polyester | 6.0 | 55 |
| | polyester resin 3 | resin 1 | | |
| Toner particle 4 | None | Polyester | 6.0 | 55 |
| | | resin 1 | | |
| Toner particle 5 | Crystalline | Polyester | 5.0 | 55 |
| | polyester resin 1 | resin 1 | | |
| Toner particle 6 | Crystalline | None | 6.0 | 55 |
| | polyester resin 1 | | | |
| Toner particle 8 | Crystalline | None | 4.0 | 55 |
| | polyester resin 1 | | | |

In the table, the particle diameter indicates the weight average particle diameter (km) of the toner particle.

### Production of Toner Particle 7

Polyester resin 1: 100.0 parts
Polyester resin 2: 88.0 parts
Release agent (hydrocarbon wax, melting point: 79° C.): 16.0 parts
Copper phthalocyanine (Pigment Blue 15:3): 10.0 parts

The above materials were mixed using a Henschel mixer (FM-75 type, manufactured by Mitsui Mining Co., Ltd.) at a rotational speed of 20 s-1 and a rotational time of 5 min, and were then kneaded in a two-screw kneader (PCM-30 type, manufactured by Ikegai Corporation) set at a temperature of 130° C. (the number of times of kneading: twice). The thus obtained kneaded product was cooled to 25° C. and was roughly pulverized to 1 mm or less with a hammer mill to thereby obtain a roughly pulverized product. The resulting roughly pulverized product was milled with a mechanical milling machine (T-250 manufactured by Turbo Industries Co., Ltd.). Classification was then performed using a multi-split classifier using the Coanda effect to thereby obtain a toner particle 7 having a weight average particle diameter (D4) of 6.0 μm.

### Production Example of Fine Particle A1

### First Process

To a reaction vessel equipped with a thermometer and a stirrer, 360 parts of water was put, and 15 parts of hydrochloric acid at a concentration of 5.0% by mass was added thereto to thereby obtain a homogeneous solution. 136.0 parts of methyltrimethoxy silane was added thereto while these were stirred at a temperature of 25° C., and the mixture was stirred for 5 hours. Thereafter, filtration was performed to obtain a clear reaction solution containing a silanol compound or a partial condensate thereof.

### Second Process

To a reaction vessel equipped with a thermometer, a stirrer, and a dropping device, 440 parts of water was input, and 17 parts of ammonia water with a concentration of 10.0% by mass was added thereto to thereby obtain a homogeneous solution. The obtained homogeneous solution was stirred at a temperature of 35° C., and 100 parts of the reaction solution obtained in the first process was added dropwise thereto over 0.50 hours and reacted for 4 hours to thereby obtain a suspension. The obtained suspension was subjected to a centrifuge separator to cause a fine particle to settle down, and the fine particle was extracted and dried for 24 hours by a drier at a temperature of 200° C.

### Third Process

100 parts of the fine particle obtained in the second process, 3.75 parts of dimethyl silicone oil (viscosity (25° C.): 100 mm²/s), and 1,000 parts of ethanol were stirred and mixed. Thereafter, a solvent was distilled off using an evaporator, and the resulting product was dried to thereby obtain the fine particle A1.

The obtained fine particle A1 had a number average particle diameter of the primary particle of 100 nm obtained by a scanning electron microscope.

### Production Examples of Fine Particles A2 to A9

Fine particles A2 to A9 were obtained similarly to the production example of the fine particle A1 other than the types and the amounts of silane compound, the amounts of materials used in each process, and the conditions of each process were changed as described in Table 3. Physical properties of the obtained fine particles A2 to A9 are shown in Table 1.

TABLE 3

| | | | | | | | | Second process |
|---|---|---|---|---|---|---|---|---|
| | First process | | | | | | | First |
| | | Hydro- | Reaction | | | | | process |
| | | chloric | temper- | | | | | reaction |
| Fine | Water | acid | ature | Silane compound | | Silane compound | | solution |
| particle A | (parts) | (parts) | (° C.) | 1 (parts) | | 2 (parts) | | (parts) |
| Fine particle A1 | 360 | 15 | 25 | Methyltrimethoxysilane | 136.0 | — | | 100 |
| Fine particle A2 | 360 | 15 | 25 | Methyltrimethoxysilane | 136.0 | — | | 100 |
| Fine particle A3 | 360 | 15 | 25 | Methyltrimethoxysilane | 136.0 | — | | 100 |
| Fine particle A4 | 360 | 15 | 25 | Methyltrimethoxysilane | 136.0 | — | | 100 |
| Fine particle A5 | 360 | 8 | 25 | Pentyltrimethoxysilane | 190.1 | Tripentylmethoxysilane | 5.0 | 100 |

| | | | | | | | |
|---|---|---|---|---|---|---|---|
| Fine particle A6 | 360 | 23 | 25 | Methyltrimethoxysilane | 136.0 | — | 100 |
| Fine particle A7 | 200 | 15 | 25 | Methyltrimethoxysilane | 136.0 | — | 100 |
| Fine particle A8 | 200 | 15 | 25 | Methyltrimethoxysilane | 136.0 | — | 100 |
| Fine particle A9 | 200 | 15 | 25 | Methyltrimethoxysilane | 136.0 | — | 100 |

| | | | | | | | Number | |
|---|---|---|---|---|---|---|---|---|
| | Second process | | | | | | average | |
| | | | Reaction | | Third process | | particle | Toluene- |
| | | | start | | Second | | diameter of | soluble |
| | | Ammonia | temper- | Reaction | process | | primary | matter |
| Fine | Water | water | ature | time | particle | PDMS | particle | (% by |
| particle A | (parts) | (parts) | (° C.) | (hr) | (parts) | (parts) | (μm) | mass) |
| Fine particle A1 | 440 | 17 | 35 | 4.00 | 100 | 3.75 | 0.100 | 2.50 |
| Fine particle A2 | 440 | 17 | 35 | 4.00 | 100 | 1.50 | 0.100 | 1.00 |
| Fine particle A3 | 440 | 17 | 35 | 4.00 | 100 | 0.30 | 0.100 | 0.20 |
| Fine particle A4 | 440 | 17 | 35 | 4.00 | 100 | 7.50 | 0.100 | 5.00 |
| Fine particle A5 | 440 | 15 | 30 | 4.00 | 100 | 3.75 | 0.050 | 2.50 |
| Fine particle A6 | 440 | 23 | 35 | 6.00 | 100 | 3.75 | 0.350 | 2.50 |
| Fine particle A7 | 500 | 17 | 40 | 6.00 | 100 | 3.75 | 3.900 | 2.50 |
| Fine particle A8 | 500 | 17 | 40 | 6.50 | 100 | 3.75 | 4.300 | 2.50 |
| Fine particle A9 | 600 | 17 | 40 | 7.00 | 100 | 63.0 | 5.000 | 42.00 |

In the table, the toluene-soluble matter indicates the content (% by mass) of toluene-soluble matter having a molecular weight of 1,000 to 10,000 with respect to the fine particle A, and PMDS indicates dimethyl silicone oil.

### Production Example of Fine Particle B1

Ilmenite ore containing 50% by mass of TiO₂ equivalent was dried at 150° C. for 3 hours, and sulfuric acid was added thereto to dissolve it, to thereby obtain an aqueous solution of TiOSO₄. The obtained aqueous solution was concentrated, and then 10 parts of the titania sol having a rutile crystal was added as a seed. Thereafter, hydrolysis was then performed at 170° C. to obtain a slurry of TiO(OH)₂ containing impurities. The obtained slurry was repeatedly washed at pH 5 to 6, sulfuric acid, FeSO₄, and impurities were sufficiently removed to thereby obtain a high-purity slurry of metatitanic acid [TiO(OH)₂].

The obtained slurry was filtered, then 0.5 parts of lithium carbonate (Li₂CO₃) was added and fired at 250° C. for 3 hours. Thereafter, crushing using a jet mill was repeated to obtain a titanium oxide fine particle having a rutile crystal. While the obtained titanium oxide fine particle was dispersed in ethanol and was stirred, 5 parts of isobutyltrimethoxy silane as a surface treatment agent was added dropwise to 100 parts of the titanium oxide fine particle to thereby cause a reaction with the titanium oxide fine particle. The obtained reaction product was dried and was then subjected to heat treatment at 170° C. for 3 hours. Furthermore, the crushing treatment with the jet mill was repeated until aggregates of titanium oxide were eliminated, and a fine particle B1 was obtained as a titanium oxide fine particle. Physical properties of the fine particle B1 are shown in Table 4.

### Production Example of Fine Particle B2

A fine particle B2 was obtained as a titanium oxide fine particle similarly to the fine particle B1 other than that the firing temperature was set to 240° C. and the amount of isobutyltrimethoxy silane as a surface treatment agent was changed to 15 parts in the production example of the fine particle B1. Physical properties of the fine particle B2 are shown in Table 4.

### Production Example of Fine Particle B3

A fine particle B3 was obtained as a titanium oxide fine particle similarly to the fine particle B1 other than that the firing temperature was changed to 260° C. in the production example of the fine particle B1. Physical properties of the fine particle B3 are shown in Table 2.

### Production Example of Fine Particle B4

After an iron removal and bleaching treatment was performed on metatitanic acid obtained by a sulfuric acid method, a sodium hydroxide aqueous solution was added to adjust pH to 9.0, and desulfurization treatment was performed. Thereafter, the mixture was neutralized to pH 5.8 with hydrochloric acid, was filtered, and was washed with water. Water was added to a washed cake to produce TiO₂, the TiO₂ was made into a 1.85 mol/L slurry, hydrochloric acid was then added thereto to adjust the pH to 1.0, and a peptization treatment was performed thereon.

The desulfurized and peptized metatitanic acid was made into TiO₂, 1.88 mol of the TiO₂ was collected and input into a 3 L reaction vessel. To the reaction vessel, 2.16 mol of a strontium chloride aqueous solution was added such that SrO/Ti (molar ratio) reached 1.15, and the TiO₂ concentration was then adjusted to 1.039 mol/L.

The slurry was then warmed to 90° C. while stirred and mixed, and 440 mL of 10 mol/L sodium hydroxide aqueous solution was added thereto over 45 minutes. Thereafter, stirring was continued at 95° C. for 1 hour to complete the reaction, to thereby obtain a reaction slurry.

The reaction slurry was cooled to 50° C., hydrochloric acid was added thereto until pH was adjusted to 5.0, and the stirring was continued for 1 hour. A resultant precipitate was decantation-washed.

A slurry containing the precipitate was adjusted to 40° C., and hydrochloric acid was added thereto to adjust the pH to 2.5. Next, 4.0% by mass of n-octyltriethoxy silane was added to the solid content, and stirring and holding were continued for 10 hours. Then, a 5 mol/L sodium hydroxide solution was added thereto to adjust pH to 6.5, and stirring was continued for 1 hour. Thereafter, a cake obtained through filtration and washing was dried in the atmosphere at 120° C. for 8 hours, to thereby obtain a fine particle B4 as a strontium titanate fine particle. Physical properties of the fine particle B4 are shown in Table 4.

### Production Example of Fine Particle B5

A fine particle B5 was obtained as a titanium oxide fine particle similarly to the fine particle B1 other than that the firing temperature was changed to 270° C. in the production example of the fine particle B1. Physical properties of the fine particle B5 are shown in Table 4.

TABLE 4

| | | | Number average |
|---|---|---|---|
| | | Volume | particle diameter |
| | | resistivity | of primary |
| Fine particle B | Material | (Ω · m) | particle (nm) |
| Fine particle B1 | Titanium oxide | 3.0 × 10⁵ | 20 |
| Fine particle B2 | Titanium oxide | 7.8 × 10⁷ | 5 |
| Fine particle B3 | Titanium oxide | 5.5 × 10⁵ | 50 |
| Fine particle B4 | Strontium titanate | 3.4 × 10⁷ | 30 |
| Fine particle B5 | Titanium oxide | 6.0 × 10⁵ | 60 |

### Production Example of Toner 1

First, as an external addition process 1, an FM mixer (FM10C type manufactured by Nippon Coke & Engineering Company, Limited) was used to mix the toner particle 1 with the fine particle B1.

In a state where the water temperature in the jacket of the FM mixer was stable at 50° C.±1° C., 100 parts of toner particles 1 and 1.0 parts of fine particle B1 were input. Mixing was started at a peripheral speed of 38 m/see of the rotating blades, and mixing was performed for 7 minutes while the water temperature and the flow amount in the jacket were controlled such that the temperature in the tank was stabilized at 50° C.±1° C., to thereby obtain a mixture of the toner particle 1 and the fine particle B1.

Subsequently, as an external addition process 2, in a state where the water temperature in the jacket of the FM mixer was stable at 25° C.±1° C., 0.5 parts of fine particle A1 and 0.8 parts of RX-200 (manufactured by Nippon Aerosil Co., Ltd.) were added to the above-described mixture of the toner particle 1 and the fine particle B1. Mixing was started at a peripheral speed of 28 m/see of the rotating blades, and mixing was performed for 4 minutes while the water temperature and the flow amount in the jacket were controlled such that the temperature in the tank was stabilized at 25° C.±1° C. Thereafter, the mixture was screened with a mesh with an opening of 75 μm to obtain the toner 1. Production conditions and various physical properties of the toner 1 are shown in Table 5.

### Production Examples of Toners 2 to 27 and 29

Toners 2 to 27 were obtained by a method similar to that of the toner 1 other than that formulation and conditions were changed to those shown in Table 5. Production conditions and various physical properties of the toners 2 to 27 are shown in Table 5.

### Production Example of Toner 28

In a state where the water temperature in the jacket of the FM mixer was stable at 25° C.±1° C., 100 parts of toner particles 8, 0.5 parts of fine particle A1, 1.2 parts of fine particle B5, and 0.8 parts of RX-200 (manufactured by Nippon Aerosil Co., Ltd.) were added thereto. Mixing was started at 3000 rpm and was performed for 10 minutes while the water temperature and the flow amount in the jacket were controlled such that the temperature in the tank was stabilized at 25° C.±1° C. Thereafter, the mixture was screened with a mesh with an opening of 75 μm to obtain the toner 28. Production conditions and various physical properties of the toner 28 are shown in Table 5.

TABLE 5

| | | | | | | | | | Particle |
|---|---|---|---|---|---|---|---|---|---|
| | | Toner | Toner | | | | | | diameter |
| | | particle | particle | | External | | Fine | | of fine |
| | Toner | diameter | diameter × | | addition | | particle | | particle B |
| Toner | particle | (μm) | 0.65 | Shell | process 1 | | B (parts) | | (nm) |
| Toner 1 | Toner | 6.0 | 3.9 | Present | 50° C. | 7 minutes | Fine | 1.0 | 20 |
| | particle 1 | | | | | | particle B1 | | |
| Toner 2 | Toner | 6.0 | 3.9 | Present | 50° C. | 7 minutes | Fine | 1.0 | 20 |
| | particle 1 | | | | | | particle B1 | | |
| Toner 3 | Toner | 6.0 | 3.9 | Present | 50° C. | 7 minutes | Fine | 1.0 | 20 |
| | particle 1 | | | | | | particle B1 | | |
| Toner 4 | Toner | 6.0 | 3.9 | Present | 50° C. | 7 minutes | Fine | 1.0 | 20 |
| | particle 1 | | | | | | particle B1 | | |
| Toner 5 | Toner | 6.0 | 3.9 | Present | 50° C. | 7 minutes | Fine | 1.0 | 5 |
| | particle 1 | | | | | | particle B2 | | |
| Toner 6 | Toner | 6.0 | 3.9 | Present | 50° C. | 7 minutes | Fine | 1.0 | 50 |
| | particle 1 | | | | | | particle B3 | | |
| Toner 7 | Toner | 6.0 | 3.9 | Present | 50° C. | 7 minutes | Fine | 1.0 | 30 |
| | particle 1 | | | | | | particle B4 | | |
| Toner 8 | Toner | 6.0 | 3.9 | Present | 50° C. | 7 minutes | Fine | 0.1 | 20 |
| | particle 1 | | | | | | particle B1 | | |
| Toner 9 | Toner | 6.0 | 3.9 | Present | 50° C. | 7 minutes | Fine | 3.0 | 20 |
| | particle 1 | | | | | | particle B1 | | |
| Toner 10 | Toner | 6.0 | 3.9 | Present | 48° C. | 7 minutes | Fine | 1.0 | 20 |
| | particle 1 | | | | | | particle B1 | | |
| Toner 11 | Toner | 6.0 | 3.9 | Present | 51° C. | 7 minutes | Fine | 1.0 | 20 |
| | particle 1 | | | | | | particle B1 | | |
| Toner 12 | Toner | 6.0 | 3.9 | Present | 52° C.: | 7 minutes | Fine | 1.0 | 20 |
| | particle 1 | | | | | | particle B1 | | |
| Toner 13 | Toner | 6.0 | 3.9 | Present | 52° C. | 10 minutes | Fine | 1.0 | 20 |
| | particle 1 | | | | | | particle B1 | | |
| Toner 14 | Toner | 6.0 | 3.9 | Present | 50° C. | 7 minutes | Fine | 1.0 | 20 |
| | particle 2 | | | | | | particle B1 | | |
| Tomer 15 | Toner | 6.0 | 3.9 | Present | 50° C. | 7 minutes | Fine | 1.0 | 20 |
| | particle 3 | | | | | | particle B1 | | |
| Toner 16 | Toner | 6.0 | 3.9 | Present | 50° C. | 7 minutes | Fine | 1.0 | 20 |
| | particle 4 | | | | | | particle B1 | | |
| Toner 17 | Toner | 6.0 | 3.9 | Present | 50° C. | 7 minutes | Fine | 1.0 | 20 |
| | particle 1 | | | | | | particle B1 | | |
| Toner 18 | Toner | 6.0 | 3.9 | Present | 50° C. | 7 minutes | Fine | 1.0 | 20 |
| | particle 1 | | | | | | particle B1 | | |
| Tomer 19 | Toner | 6.0 | 3.9 | Present | 50° C. | 7 minutes | Fine | 1.0 | 20 |
| | particle 1 | | | | | | particle B1 | | |
| Toner 20 | Toner | 6.0 | 3.9 | Present | 50° C. | 7 minutes | Fine | 1.0 | 20 |
| | particle 1 | | | | | | particle B1 | | |
| Toner 21 | Toner | 5.0 | 3.25 | Present | 50° C. | 7 minutes | Fine | 1.0 | 20 |
| | particle 5 | | | | | | particle B1 | | |
| Tomer 22 | Toner | 6.0 | 3.9 | Present | 50° C. | 7 minutes | Fine | 1.0 | 60 |
| | particle 1 | | | | | | particle B5 | | |
| Toner 23 | Toner | 6.0 | 3.9 | Present | 50° C. | 7 minutes | Fine | 1.0 | 20 |
| | particle 1 | | | | | | particle B1 | | |
| Toner 24 | Toner | 6.0 | 3.9 | Present | 51° C. | 4 minutes | Fine | 1.0 | 20 |
| | particle 1 | | | | | | particle B1 | | |
| Tomer 25 | Toner | 6.0 | 3.9 | Present | 48° C. | 20 minutes | Fine | 1.0 | 20 |
| | particle 1 | | | | | | particle B1 | | |
| Toner 26 | Toner | 6.0 | 3.9 | Absent | 50° C. | 7 minutes | Fine | 1.0 | 20 |
| | particle 6 | | | | | | particle B1 | | |
| Toner 27 | Toner | 6.0 | 3.9 | Absent | 50° C. | 7 minutes | Fine | 1.0 | 60 |
| | particle 7 | | | | | | particle B5 | | |
| Toner 28 | Toner | 4.0 | 3.9 | Absent | Described in | | Fine | 1.2 | 50 |
| | particle 8 | | | | specification | | particle B5 | | |
| Toner 29 | Toner | 6.0 | 3.9 | Absent | 50° C. | 7 minutes | Fine | 1.0 | 20 |
| | particle 7 | | | | | | particle B1 | | |

| | | | | Dispersion | | | Particle |
|---|---|---|---|---|---|---|---|
| | Embedding | | | degree | | | diameter |
| | rate of | | | evaluation | Fine | | of fine |
| | fine | | | index of fine | particle A | | particle A |
| Toner | particle B | C | C/{B1/(B1 + B2)} | particle B | (parts) | | (nm) |
| Toner 1 | 70 | 0.077 | 0.11 | 0.3 | Fine | 0.5 | 0.100 |
| | | | | | particle A1 | | |
| Toner 2 | 70 | 0.084 | 0.12 | 0.3 | Fine | 0.5 | 0.100 |
| | | | | | particle A2 | | |
| Toner 3 | 70 | 0.077 | 0.11 | 0.3 | Fine | 0.5 | 0.100 |
| | | | | | particle A3 | | |
| Toner 4 | 70 | 0.077 | 0.11 | 0.3 | Fine | 0.5 | 0.100 |
| | | | | | particle A4 | | |
| Toner 5 | 70 | 0.077 | 0.11 | 0.3 | Fine | 0.5 | 0.100 |
| | | | | | particle A1 | | |
| Toner 6 | 70 | 0.084 | 0.12 | 0.3 | Fine | 0.5 | 0.100 |
| | | | | | particle A1 | | |
| Toner 7 | 70 | 0.077 | 0.11 | 0.3 | Fine | 0.5 | 0.100 |
| | | | | | particle A1 | | |
| Toner 8 | 70 | 0.077 | 0.11 | 0.3 | Fine | 0.5 | 0.100 |
| | | | | | particle A1 | | |
| Toner 9 | 70 | 0.077 | 0.11 | 0.3 | Fine | 0.5 | 0.100 |
| | | | | | particle A1 | | |
| Toner 10 | 50 | 0.075 | 0.15 | 0.3 | Fine | 0.5 | 0.100 |
| | | | | | particle A1 | | |
| Toner 11 | 85 | 0.077 | 0.09 | 0.3 | Fine | 0.5 | 0.100 |
| | | | | | particle A1 | | |
| Toner 12 | 90 | 0.081 | 0.09 | 0.3 | Fine | 0.5 | 0.100 |
| | | | | | particle A1 | | |
| Toner 13 | 95 | 0.076 | 0.08 | 0.3 | Fine | 0.5 | 0,100 |
| | | | | | particle A1 | | |
| Toner 14 | 70 | 0.091 | 0.13 | 0.3 | Fine | 0.5 | 0.100 |
| | | | | | particle A1 | | |
| Tomer 15 | 70 | 0.091 | 0.13 | 0.3 | Fine | 0.5 | 0.100 |
| | | | | | particle A1 | | |
| Toner 16 | 70 | 0.077 | 0.11 | 0.3 | Fine | 0.5 | 0.100 |
| | | | | | particle A1 | | |
| Toner 17 | 70 | 0.084 | 0.12 | 0.3 | Fine | 0.5 | 0.050 |
| | | | | | particle A5 | | |
| Toner 18 | 70 | 0.091 | 0.13 | 0.3 | Fine | 0.5 | 0.350 |
| | | | | | particle A6 | | |
| Tomer 19 | 70 | 0.077 | 0.11 | 0.3 | Fine | 0.5 | 3.900 |
| | | | | | particle A7 | | |
| Toner 20 | 70 | 0.091 | 0.13 | 0.3 | Fine | 0.5 | 4.300 |
| | | | | | particle A8 | | |
| Toner 21 | 70 | 0.084 | 0.12 | 0.3 | Fine | 0.5 | 0.100 |
| | | | | | particle A1 | | |
| Tomer 22 | 70 | 0.077 | 0.11 | 0.3 | Fine | 0.5 | 0.100 |
| | | | | | particle A1 | | |
| Toner 23 | 70 | 0.161 | 0.23 | 0.4 | Fine | 0.5 | 0.100 |
| | | | | | particle A1 | | |
| Toner 24 | 70 | 0.231 | 0.33 | 0.6 | Fine | 0.5 | 0.100 |
| | | | | | particle A1 | | |
| Tomer 25 | 70 | 0.091 | 0.13 | 0.1 | Fine | 0.5 | 0.100 |
| | | | | | particle A1 | | |
| Toner 26 | 70 | 0.091 | 0.13 | 0.3 | Fine | 0.5 | 0.100 |
| | | | | | particle A1 | | |
| Toner 27 | 70 | 0.217 | 0.31 | 0.6 | Fine | 0.5 | 4.300 |
| | | | | | particle A8 | | |
| Toner 28 | 20 | 0.102 | 0.51 | 1.0 | Fine | 0.4 | 5.000 |
| | | | | | particle A9 | | |

| | | | | | | |
|---|---|---|---|---|---|---|
| Toner 29 | 70 | 0.238 | 0.34 | 0.6 | None | — |

In the table, the toner particle diameter represents the weight average particle diameter (m) of the toner, and the particle diameter of the fine particle A represents the number average particle diameter (m) of the fine particle A.

### Example 1

The toner 1 was evaluated as follows.

### Toner Evaluation

A remodeling machine of a commercially available laser beam printer “LBP7600C” from Canon Inc. was used. As a modification point, the number of revolutions of a developing roller was set such that it rotated at a peripheral speed of 1.5 times the speed of a drum by changing a gear of an evaluation machine main body and software. It is possible to more strictly evaluate durability of the toner by adopting such setting.

### Evaluation of Fogging

The following evaluations were performed in both an environment at a normal temperature and a normal humidity (a temperature of 23° C./a humidity of 60% RH) and an environment at a low temperature and a low humidity (15° C./10% RH). After 4000 sheets of images with a printing rate of 1% were output, an all white image was output, and fogging concentration of the sheet after duration was measured.

Reflectance (%) of all white image output after the durability test was measured at three points using “REFLECTOMETER MODEL TC-6DS” (Tokyo Denshoku Co., Ltd.), and an arithmetic mean value thereof was calculated. Evaluation was performed on the basis of the following criteria using numerical values (%) obtained by subtracting the arithmetic mean value of the obtained reflectance from an arithmetic mean value (%) of reflectance of an unused sheet (standard sheet) measured in a similar manner. The evaluation results are shown in Table 6. Evaluation of C or higher corresponds to an acceptable level.

### Fogging Evaluation Criteria

A: Less than 0.5%
B: 0.5% or more and less than 1.5%
C: 1.5% or more and less than 3.0%
D: 3.0% or more and less than 4.5%
E: 4.5% or more

### Evaluation of Decrease in Density

A solid image was output by the following procedure to evaluate a decrease in density in an environment at a low temperature and a low humidity (15° C./10% RH).
(1) Three copies of solid images were output.
(2) 4000 images with a printing rate of 1% were output.
(3) Three copies of solid images were output.

The image density was measured by measuring relative density to an image of the white background portion with image density of 0.00 using the Macbeth reflective densitometer RD918 (manufactured by Macbeth) in accordance with the accompanying instructions. The obtained relative density was defined as a value of image density. Durable development properties were determined on the basis of a degree of decrease in density. The degree of decrease in density was evaluated on the basis of the following criteria for the values of (initial density)—(durable density), where the arithmetic mean value of the density at the center of the three images output in (1) was used as initial density and the arithmetic mean value of the density at the center of the three images output in (3) was defined as durable density. The evaluation results are shown in Table 6. Evaluation of C or higher corresponds to an acceptable level.

### Evaluation Criteria for Decrease in Density

A: Less than 0.05
B: Equal to or greater than 0.05 and less than 0.10
C: Equal to or greater than 0.10 and less than 0.15
D: Equal to or greater than 0.15 and less than 0.20
E: Equal to or greater than 0.20%

### Evaluation of Image Flow

Image flow in an environment at a high temperature and a high humidity (30° C./80% RH) was evaluated by the following method.

Color laser copier sheets from Canon Inc. (A4: 81.4 g/m²; hereinafter, the same sheets were used unless otherwise particularly specified) were used as evaluation sheets.

After 10,000 sheets of paper a day were continuously passed at a printing rate of 1%, the sheets were left for one day in the machine, and the presence or absence of image flow after leaving them was compared. One half-tone image was output as an image sample, and evaluation was performed. Evaluation was performed every time 10,000 sheets of paper were caused to pass, and the evaluation was continued up to 30,000 sheets of paper. Evaluation criteria were as follows. The evaluation results are shown in Table 6. Evaluation of C or higher corresponds to an acceptable level.
A: There were no occurrence of a white void due to latent image dulling and a contour blur at an image boundary part
B: Slight contour blur at an image boundary part occurred in a part of an image due to latent image dulling
C: White void and contour blur at an image boundary part occurred in a part of an image due to latent image dulling
D: White void and contour blur at an image boundary part occurred in an entire region of an image due to latent image dulling

### Examples 2 to 27

Evaluation similar to that in Example 1 was performed using each of the toners 2 to 27. The evaluation results are shown in Table 6.

### Comparative Examples 1 and 2

Evaluation similar to that in Example 1 was performed using each of toners 28 and 29 as Comparative Examples 1 and 2. The evaluation results are shown in Table 6.

TABLE 6

| | | NN | LL | LL density | Image |
|---|---|---|---|---|---|
| | Toner | fogging | fogging | decrease | deletion |
| Example 1 | Toner 1 | A(0.1%) | A(0.2%) | A(0.02) | A |
| Example 2 | Toner 2 | A(0.2%) | A(0.3%) | A(0.03) | A |
| Example 3 | Toner 3 | A(0.1%) | A(0.2%) | A(0.02) | A |
| Example 4 | Toner 4 | A(0.3%) | A(0.4%) | A(0.02) | A |
| Example 5 | Toner 5 | A(0.2%) | A(0.3%) | A(0.03) | A |
| Example 6 | Toner 6 | A(0.2%) | A(0.3%) | A(0.02) | A |
| Example 7 | Toner 7 | A(0.2%) | A(0.3%) | A(0.04) | A |
| Example 8 | Toner 8 | A(0.2%) | A(0.2%) | A(0.02) | A |
| Example 9 | Toner 9 | A(0.2%) | A(0.2%) | A(0.03) | A |
| Example 10 | Toner 10 | A(0.4%) | A(0.4%) | A(0.02) | A |
| Example 11 | Toner 11 | A(0.2%) | A(0.3%) | A(0.03) | A |
| Example 12 | Toner 12 | A(0.2%) | A(0.3%) | A(0.02) | A |
| Example 13 | Toner 13 | A(0.4%) | A(0.4%) | A(0.04) | A |
| Example 14 | Toner 14 | A(0.1%) | A(0.2%) | A(0.03) | A |
| Example 15 | Toner 15 | A(0.1%) | A(0.2%) | A(0.02) | A |
| Example 16 | Toner 16 | B(0.7%) | C(1.6%) | A(0.03) | A |
| Example 17 | Toner 17 | A(0.1%) | A(0.2%) | A(0.02) | A |
| Example 18 | Toner 18 | A(0.2%) | A(0.3%) | A(0.04) | B |
| Example 19 | Toner 19 | A(0.2%) | A(0.3%) | B(0.08) | B |
| Example 20 | Toner 20 | A(0.1%) | A(0.2%) | C(0.13) | 0 |
| Example 21 | Toner21 | A(0.1%) | A(0.2%) | A(0.04) | A |
| Example 22 | Toner 22 | B(0.7%) | B(0.7%) | A(0.04) | A |
| Example 23 | Toner 23 | A(0.2%) | A(0.3%) | A(0.03) | A |
| Example 24 | Toner 24 | B(0.7%) | B(0.7%) | A(0.04) | A |
| Example 25 | Toner 25 | A(0.2%) | A(0.3%) | A(0.03) | A |
| Example 26 | Toner 26 | A(0.4%) | A(0.4%) | A(0.04) | A |
| Example 27 | Toner 27 | C(1.6%) | C(2.5%) | C(0.13) | C |
| Comparative | Toner 28 | D(4.3%) | E(5.2%) | E(0.32) | D |
| Example 1 | | | | | |
| Comparative | Toner 29 | E(4.8%) | E(5.8%) | E(0.34) | D |
| Example 2 | | | | | |

According to the present disclosure, there is provided a toner that is excellent in durability without using a fluorine compound in consideration of effects on an environment and the human body. Specifically, there is provided a toner that curbs toner degradation due to a stress received through long-term printing, curbs adverse image effects such as fogging in an environment at a normal temperature and a normal humidity and an environment at a low temperature and a low humidity and a decrease in density in an environment at a low temperature and a low humidity, and curbs image flow by curbing surface contamination of the latent image bearing member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188221, filed Oct. 25, 2024, which is hereby incorporated by reference herein in its entirety.

What is claimed is:

1. A toner comprising: a toner particle; and a fine particle A and a fine particle B on a surface of the toner particle,
wherein the fine particle A is an organosilicon polymer particle,
the fine particle A comprises 0.20% by mass to 5.00% by mass of toluene-soluble matter having a molecular weight of 1,000 to 10,000 with respect to the fine particle A,
a volume resistivity of the fine particle B is 5.0×10¹ to 1.0×10⁸Ω·m,
a content of the fine particle B in the toner is 0.1 to 3.0 parts by mass with respect to 100 parts by mass of the toner particle, and
when a total area of the fine particle B which is present on a contour of a section of the toner particle and within 30 nm from the contour of the section of the toner particle is defined as B1 (pixel) and a total area of the fine particle B which is present outside the contour of the section of the toner particle is defined as B2 (pixel) in section observation of the toner with a scanning transmission electron microscope, B1 and B2 satisfy Expression (1) below:
$$50 \leq B 1 / ( B 1 + B 2 ) \times 100 \leq 100. \qquad ( 1 )$$

2. The toner according to claim 1, wherein the toner particle comprises a crystalline polyester resin.

3. The toner according to claim 1, wherein when a number average particle diameter of a primary particle of the fine particle A is defined as X (μm), and a weight average particle diameter of the toner is defined as Y (μm), X and Y satisfy Expression (2) below:
$$0.05 \leq X \leq Y \times 0.65 \qquad ( 2 )$$

4. The toner according to claim 1, wherein a number average particle diameter of a primary particle of the fine particle B is 5 to 50 nm.

5. The toner according to claim 1, wherein the fine particle B comprises at least one selected from the group consisting of a titanium oxide fine particle and a strontium titanate fine particle.

6. The toner according to claim 1, wherein a dispersion degree evaluation index of the fine particle B is 0.4 or less.

7. The toner according to claim 1, wherein the toner particle has a core-shell structure.

8. The toner according to claim 1, wherein when a standard deviation of B1/(B1+B2) is defined as C in the section observation of the toner with the scanning transmission electron microscope, B1, B2, and C satisfy Expression (3) below:
$$0. \leq C / \{ B 1 / ( B 1 + B 2 ) \} \leq 0 \text{.22} . \qquad ( 3 )$$
